(19) United States
(12) Patent Application Publication
(10) Pub. No.: US 2025/0283191 A1
(43) Pub. Date: Sep. 11, 2025

(54) METHODS AND SYSTEMS OF ACID-BASE LEACHING FOR INDUSTRIAL BYPRODUCTS

(71) Applicant: Sublime Systems, Inc., Somerville, MA (US)

(72) Inventors: Michael C. STERN, Sudbury, MA (US); Varada PALAKKAL, Canton, MA (US); Joseph P. HITTINGER, Somerville, MA (US); Natalie A. PUNDSACK, Cambridge, MA (US); Mitchell Hans SHAPIRO-ALBERT, Somerville, MA (US); Bryan J. MACDONALD, Lowell, MA (US); Sophia Michelle MITTMAN, Boston, MA (US); Lina Marie GANNON, Boston, MA (US); Jesse Daniel BENCK, Somerville, MA (US); Michael J. FORTE, Cambridge, MA (US); Margaret E. RZUCIDLO, Somerville, MA (US)

(73) Assignee: Sublime Systems, Inc., Somerville, MA (US)

(21) Appl. No.: 19/075,548

(22) Filed: Mar. 10, 2025

Related U.S. Application Data
(60) Provisional application No. 63/563,684, filed on Mar. 11, 2024.

(51) Int. Cl. C22B 7/00; C01F 5/14; C01F 7/36; C01F 11/02; C22B 3/44; C22B 21/00; C22B 26/22

(52) U.S. Cl. CPC C22B 7/007; C01F 5/14; C01F 7/36; C01F 11/02; C22B 3/44; C22B 21/0015; C22B 26/22

(57) ABSTRACT

Disclosed herein are acid-base leaching methods and systems. Specifically, the systems and methods can include reacting a feed material comprising at least two metals selected from the group consisting of iron, magnesium, and calcium with a weak acid to produce a first leachate comprising ions of the at least two metals and an insoluble product; reacting the first leachate with a base to produce a first solid product comprising a first metal and a second leachate comprising ions of a second metal different from the first metal; and reacting the second leachate with the base to produce a second solid product comprising the second metal and a third leachate.

### CROSS-REFERENCE TO RELATED APPLICATIONS

This application claims the benefit of U.S. Provisional Application No. 63/563,684 filed Mar. 11, 2024, the entire contents of which are incorporated herein by reference.

### GOVERNMENT SUPPORT CLAUSE

This invention was made with government support under Award No. DE-AR0001599 awarded by the Advanced Research Project Agency-Energy (ARPA-E) of the U.S. Department of Energy to Sublime Systems, Inc. The government has certain rights in the invention.

### FIELD

The present disclosure relates generally to systems and methods for acid-base leaching. More specifically, this disclosure relates to systems and methods for acid-base leaching using a weak acid.

### BACKGROUND

Acid leaching of slags and other industrial waste residues containing metal oxides allows for the extraction of many desired materials, such as precious metals, transition metals, alkali metals, oxides thereof, and the like. The cost of acid leaching can largely be dependent on the type of acid and amount of acid consumed during the leaching process, and the difficulty of the subsequent separation steps to recover the mix of leached components in the leachate stream. Conventional leaching processes typically involve the addition of a sufficient amount of acid to simultaneously dissolve all the desired materials at a low pH and then the addition of a base to sequentially precipitate individual component streams.

In addition, conventional processes for the extraction of alkali metals, such as calcium (Ca) and magnesium (Mg), use carbon dioxide or carbonates to precipitate calcium carbonate and/or magnesium carbonate and then calcine the carbonated salts to form calcium oxide and magnesium oxide. Calcining carbonated salts, however, can lead to greater environmental impact due to carbon emissions from the combustion of heating fuel and due to the release of carbon dioxide from the carbonated salts.

Depending on the pretreatment of the materials being leached and the conditions of the leaching, the silicate and aluminosilicate portions of the material may form polymerized networks known as silica gels. Silica gels may have some desirable properties, such as high surface area, but can have some negative properties including high liquid retention, poor filterability, and poor flow properties. Silicates, silicas, and aluminosilicates can be effective pozzolans for the production of pozzolanic cement, but specific pretreatment and reaction conditions may be necessary to form materials suitable for this purpose.

### BRIEF SUMMARY

Many industrial byproducts or wastes including metallurgical slags, combustion ashes, mining tailings, recycled concrete, and/or kiln dusts can include high concentrations of alkaline earth metals. However, these are typically landfilled or used as inexpensive road base. Recovering the alkaline earth metals from these materials can avoid the need to calcine additional limestone and/or dolomite and improve overall circularity.

Dissolving these feedstocks with strong acids, however, may be prohibitively expensive due to the large acid consumption required and complicated separation of the dissolved components. In contrast, using a weak acid can reduce the quantity of acid required to extract the alkaline earth metals because the weak acid dissolves less iron and/or aluminum reducing the acid consumption. Dissolving less components can also reduce the number of subsequent separation steps required to produce purer precipitated components. Applicant has discovered improved leaching methods and systems that can reduce acid consumption and carbon dioxide emissions, thereby reducing costs and environmental impacts. Further, such methods can generate suitable pozzolanic materials for cement production and can generate concentrated streams of other saleable products such as magnesium hydroxide, iron oxides and hydroxides, and other high value metals (or their oxide or hydroxides) including manganese, chromium, and nickel to reduce waste and improve the economics of the process.

Disclosed herein are systems and methods for extracting desired materials from industrial waste materials, byproducts, and/or natural minerals. In some embodiments, provided is an acid-base leaching method including: supplying a feedstock material comprising an alkaline earth metal and an weak acid to a first reaction chamber to form a first process stream comprising an alkaline earth metal salt and a first product comprising silicon, aluminum, and/or iron oxides or hydroxides; supplying the first process stream and hydroxide containing base to one or more additional reaction chambers to form one or more precipitated oxide or hydroxide products and a last process stream comprising a neutralized brine that comprises the weak acid anion.

In some embodiments, provided is an acid-base leaching method including: supplying a feed material comprising an alkaline earth metal oxide, hydroxide, and/or carbonate and an acid to a first reaction chamber to form a first process stream comprising a calcium salt and a first insoluble product comprising suspended silicon dioxide (SiO₂), aluminum hydroxide (Al(OH)₃), aluminum oxide (Al₂O₃), aluminum oxyhydroxide (AlOOH), and/or oxyhydroxides of iron; supplying the first process stream and a hydroxide containing base to a second reaction chamber to form a second process stream comprising alkaline earth metal salts and a precipitated iron oxide product; supplying the second process stream and a hydroxide containing base to form a third process stream and a first precipitate product comprising a precipitated magnesium hydroxide Mg(OH)₂); supplying the third process stream and a hydroxide containing base to a fourth reaction chamber to form a precipitated calcium hydroxide Ca(OH)₂ product and a brine stream; supplying the brine stream to an electrolyzer configured to generate the acid and a base; using direct electrowinning, liquid-liquid extraction with a non-aqueous solvent, or an ion-exchange system to remove a high value transition metal comprising manganese, chromium, and/or nickel to produce a fifth process stream comprising a hydroxide salt or metallic form of one or more high value transition metals.

In some embodiments, a method includes producing a weak acid and a base; reacting a feed material comprising at least two metals selected from the group consisting of iron, magnesium, and calcium with the weak acid to produce a first leachate comprising ions of the at least two metals and an insoluble product; reacting the first leachate with the base to produce a first solid product comprising a first metal and a second leachate comprising ions of a second metal different from the first metal; and reacting the second leachate with the base to produce a second solid product comprising the second metal and a third leachate, wherein reacting the second leachate with the base occurs at a higher pH than reacting the first leachate with the base. In some embodiments, the weak acid comprises acetic acid (CH₃COOH); and the base comprises sodium hydroxide (NaOH) and/or potassium hydroxide (KOH). In some embodiments, the insoluble product comprises silicon dioxide (SiO₂) and/or aluminosilicate. In some embodiments, the second solid product comprises calcium hydroxide. In some embodiments, the first solid product comprises magnesium hydroxide. In some embodiments, the method includes prior to reacting the feed material with the weak acid, reacting the feed material with the base to produce a fourth leachate comprising aluminum, wherein the feed material comprises aluminum. In some embodiments, the method includes reacting the insoluble product with the base to produce a fifth leachate comprising aluminum, wherein the feed material comprises aluminum. In some embodiments, the method includes precipitating the aluminum from the fourth and/or fifth leachate using a temperature swing and/or through the addition of an acid or acid gas. In some embodiments, the aluminum is precipitated using carbon dioxide forming a carbonate salt and the carbonate salt is added to the reaction of the first leachate with the base to produce the first solid product. In some embodiments, the aluminum is precipitated using the weak acid to form aluminum hydroxide and a sixth leachate comprising the anion of the weak acid. In some embodiments, the method includes extracting a transition metal comprising nickel, manganese, chromium, and/or molybdenum, wherein the feed material comprises the transition metal. In some embodiments, extracting comprises a liquid-liquid extraction or an ion exchange resin and removes the transition metal from the first and/or second leachate. In some embodiments, reacting the feed material with the weak acid occurs in a first reaction chamber comprising regions of different pH or a pH that varies temporally. In some embodiments, the different pH regions are sequential reactors or spatially differentiated regions within a plug flow reactor. In some embodiments, the first reaction chamber is a batch or semi-batch reactor where the pH varies temporally. In some embodiments, the variation in pH causes a portion of aluminum or iron in the feed material to dissolve and then precipitate and to be incorporated into the insoluble product. In some embodiments, the insoluble product comprises more than 5 wt. % material precipitated in the first reaction chamber. In some embodiments, reacting the feed material with the weak acid occurs at a pH of about 2 to about 7; reacting the first leachate with the base occurs at a pH of about 6 to about 11; and reacting the second leachate with the base occurs at a pH of about 7 to about 13. In some embodiments, the method includes controlling pH during the reactions such that reacting the feed material with the weak acid occurs at a first pH, reacting the first leachate with the base occurs at a second pH higher than the first pH, and reacting the second leachate with the base occurs at a third pH higher than the second pH. In some embodiments, weak acid consumption is less than 25 moles of weak acid per kg of feed material. In some embodiments, more than 75 wt. % of the iron in the feed material ends up in the insoluble product. In some embodiments, a mass ratio of calcium to iron in the first leachate is greater than 5. In some embodiments, feed material comprises a metallurgical slag, municipal solid waste, mine tailings, limestone, dolomitic limestone, natural silicate minerals such as basalt, and/or recycled concrete. In some embodiments, the feed material comprises more than 10 wt. % iron as measured as Fe₂O₃ by XRF. In some embodiments, the weak acid and base are produced by an electrochemical system. In some embodiments, the weak acid and base are regenerated. In some embodiments, the electrochemical system is an electrolyzer. In some embodiments, the method includes reacting the third leachate with the base to produce a third solid product comprising a third metal different from the first and second metals and a seventh leachate; and generating the weak acid and the base in the electrolyzer using the seventh leachate. In some embodiments, reacting the third leachate with the base occurs at a higher pH than reacting the second leachate with the base.

In some embodiments, a system includes a first reaction chamber configured to receive a feed material comprising at least two metals selected from the group consisting of iron, magnesium, and calcium and a weak acid and react the feed material with the weak acid to produce a first leachate comprising ions of the at least two metals and an insoluble product; a second reaction chamber configured to receive the first leachate and a base and react the first leachate with the base to produce a first solid product comprising a first metal and a second leachate comprising ions of a second metal different from the first metal; and a third reaction chamber configured to receive the second leachate and the base and react the second leachate with the base to produce a second solid product comprising the second metal and a third leachate, wherein the third reaction chamber is maintained at a higher pH than the second reaction chamber. In some embodiments, the system includes a liquid-liquid extractor or an ion exchange resin configured to remove at least one transition metal from the first and/or second leachate. In some embodiments, the first reaction chamber comprises regions of different pH or a pH that varies temporally. In some embodiments, the first reaction chamber is a batch or semi-batch reactor where the pH varies temporally. In some embodiments, a pH of the first reaction chamber is maintained at about 2-7; a pH of the second reaction chamber is maintained at about 6-11; and a pH of the third reaction chamber is maintained at about 7-13. In some embodiments, the system includes an electrolyzer configured to generate the weak acid and the base. In some embodiments, the system includes a fourth reaction chamber configured to receive the third leachate and the base and react the third leachate with the base to produce a third solid product comprising a third metal different from the first and second metals and a fourth leachate; and generating the weak acid and the base in the electrolyzer using the fourth leachate.

In some embodiments, two acids are used to leach the feedstock material in sequential steps. For example, a first acid can contact the feedstock in a first chamber where it selectively extracts calcium and/or magnesium into a first leachate and generates a first insoluble product. After the initial extraction, the first insoluble product can contact a second acid possessing a lower pKa and/or pH than the first acid where additional cations comprising magnesium, iron, aluminum, and/or manganese can be extracted into a second leachate and generate a second insoluble product. The first leachate can be contacted with a first base to form a first precipitated product and a first brine. The second leachate can be contacted with a second base to form a second precipitated product and a second brine.

In some embodiments, a method includes reacting a feed material comprising at least two metals selected from the group consisting of iron, magnesium, and calcium with a weak acid at a pH of 2-7 to produce a first leachate comprising ions of the at least two metals and an insoluble product, wherein the weak acid consumption of the reaction is less than 25 moles of weak acid per kg of feed material; reacting the first leachate with a base to produce a first solid product comprising a first metal and a second leachate comprising ions of a second metal different from the first metal; and reacting the second leachate with the base to produce a second solid product comprising the second metal and a third leachate, wherein reacting the second leachate with the base occurs at a higher pH than reacting the first leachate with the base. In some embodiments, the weak acid comprises an organic acid selected from the group consisting of formic acid, chloroacetic acid, dichloroacetic acid, and acetic acid (CH₃COOH); and the base comprises sodium hydroxide (NaOH), ammonium hydroxide, or potassium hydroxide (KOH). In some embodiments, the insoluble product comprises silicates, silicon dioxide (SiO₂), and/or aluminosilicate. In some embodiments, the second solid product comprises calcium hydroxide. In some embodiments, the first solid product comprises magnesium hydroxide. In some embodiments, an amount of weak acid used in the reaction is between 80% and 120% of the stoichiometric amount required to dissolve all calcium oxide in the feed material as measured by XRF and assuming two moles of acid are required per mole of calcium oxide. In some embodiments, calcium cations make up at least 80% by weight of all leached cations in the first leachate as measured by ICP of the first leachate. In some embodiments, an amount of weak acid used in the reaction is between 80% and 120% of the stoichiometric amount required to dissolve all calcium oxide and magnesium oxide in the feed material as measured by XRF and assuming two moles of acid are required per mole of calcium oxide and two moles of acid are required per mole of magnesium oxide. In some embodiments, calcium and magnesium cations make up at least 80% by weight of all leached cations in the first leachate as measured by ICP of the first leachate. In some embodiments, the second solid product has a platelet morphology with as aspect ratio greater than 2. In some embodiments, the second solid product has a tap density greater than 0.8 g/mL. In some embodiments, the method includes reacting the insoluble product with a second acid having a lower pKa than the weak acid to produce a second insoluble product and a leachate of the second acid. In some embodiments, the second acid comprises chloroacetic acid, dichloroacetic acid, lactic acid, formic acid, citric acid, oxalic acid, monobasic citrate, monobasic phosphate, dibasic phosphate, bisulfate, or bicarbonate. In some embodiments, the method includes, prior to reacting the feed material with the weak acid, reacting the feed material with the base to produce a fourth leachate comprising aluminum, wherein the feed material comprises aluminum. In some embodiments, the method includes reacting the insoluble product with the base to produce a fifth leachate comprising aluminum, wherein the feed material comprises aluminum. In some embodiments, the method includes precipitating the aluminum from the fourth and/or fifth leachate using a temperature swing and/or through the addition of an acid or acid gas. In some embodiments, the aluminum is precipitated using carbon dioxide forming a carbonate salt and the carbonate salt is added to the reaction of the first leachate with the base to produce the first solid product. In some embodiments, the aluminum is precipitated using the weak acid to form aluminum hydroxide and a sixth leachate comprising the anion of the weak acid. In some embodiments, the method includes extracting a transition metal comprising nickel, manganese, chromium, and/or molybdenum, wherein the feed material comprises the transition metal. In some embodiments, extracting comprises a liquid-liquid extraction or an ion exchange resin and removes the transition metal from the first and/or second leachate. In some embodiments, reacting the feed material with the weak acid occurs in a first reaction chamber comprising regions of different pH or a pH that varies temporally. In some embodiments, the different pH regions are sequential reactors or spatially differentiated regions within a plug flow reactor. In some embodiments, the first reaction chamber is a batch or semi-batch reactor where the pH varies temporally. In some embodiments, the variation in pH causes a portion of aluminum or iron in the feed material to dissolve and then precipitate and to be incorporated into the insoluble product. In some embodiments, the insoluble product comprises more than 5 wt. % material precipitated in the first reaction chamber. In some embodiments, the insoluble product comprises more than 90% of aluminum in the feed material. In some embodiments, reacting the first leachate with the base occurs at a pH of about 6 to about 11; and reacting the second leachate with the base occurs at a pH of about 7 to about 13. In some embodiments, the method includes controlling pH during the reactions such that reacting the feed material with the weak acid occurs at a first pH, reacting the first leachate with the base occurs at a second pH higher than the first pH, and reacting the second leachate with the base occurs at a third pH higher than the second pH. In some embodiments, more than 75 wt. % of the iron in the feed material ends up in the insoluble product. In some embodiments, a mass ratio of calcium to iron in the first leachate is greater than 5. In some embodiments, the feed material is a metallurgical slag, municipal solid waste, mine tailings, and/or recycled concrete. In some embodiments, the feed material comprises more than 10 wt. % iron as measured as Fe₂O₃ by XRF. In some embodiments, the weak acid and base are produced by an electrochemical system. In some embodiments, the weak acid and base are regenerated. In some embodiments, the electrochemical system is an electrolyzer. In some embodiments, the electrochemical system uses electrodialysis. In some embodiments, reacting the third leachate with the base to produce a third solid product comprising a third metal different from the first and second metals and a seventh leachate; and generating the weak acid and the base in the electrolyzer using the seventh leachate. In some embodiments, reacting the third leachate with the base occurs at a higher pH than reacting the second leachate with the base.

In some embodiments, a system includes a first reaction chamber configured to receive a feed material comprising at least two metals selected from the group consisting of iron, magnesium, and calcium and a weak acid and react the feed material with the weak acid at a pH of 2-7 to produce a first leachate comprising ions of the at least two metals and an insoluble product, wherein the weak acid consumption of the reaction is less than 25 moles of weak acid per kg of feed material; a second reaction chamber configured to receive the first leachate and a base and react the first leachate with the base to produce a first solid product comprising a first metal and a second leachate comprising ions of a second metal different from the first metal; and a third reaction chamber configured to receive the second leachate and the base and react the second leachate with the base to produce a second solid product comprising the second metal and a third leachate, wherein the third reaction chamber is maintained at a higher pH than the second reaction chamber. In some embodiments, the system includes a liquid-liquid extractor or an ion exchange resin configured to remove at least one transition metal from the first and/or second leachate. In some embodiments, the first reaction chamber comprises regions of different pH or a pH that varies temporally. In some embodiments, the first reaction chamber is a batch or semi-batch reactor where the pH varies temporally. In some embodiments, a pH of the second reaction chamber is maintained at about 6-11; and a pH of the third reaction chamber is maintained at about 7-13. In some embodiments, the system includes an electrolyzer configured to generate the weak acid and the base. In some embodiments, the system includes a fourth reaction chamber configured to receive the third leachate and the base and react the third leachate with the base to produce a third solid product comprising a third metal different from the first and second metals and a fourth leachate; and generating the weak acid and the base in the electrolyzer using the fourth leachate.

The embodiments disclosed above are only examples, and the scope of this disclosure is not limited to them. Particular embodiments may include all, some, or none of the components, elements, features, functions, operations, or steps of the embodiments disclosed above. Embodiments according to the disclosure herein are in particular disclosed in the attached claims directed to a methods, systems and materials, wherein any feature mentioned in one claim category, e.g., method, can be claimed in another claim category, e.g., system or material, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Additional advantages will be readily apparent to those skilled in the art from the following detailed description. The examples and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### DESCRIPTION OF FIGURES

The present application can be understood by reference to the following description taken in conjunction with the accompanying figures.

FIG. 1 illustrates an exemplary schematic diagram of a leaching system in accordance with some embodiments disclosed herein.

FIG. 2 illustrates an exemplary schematic diagram of a leaching system with transition metal extraction in accordance with some embodiments disclosed herein.

FIG. 3 illustrates an exemplary schematic diagram of a leaching system that includes base leaching of aluminum in accordance with some embodiments disclosed herein.

FIG. 4 illustrates an exemplary schematic diagram of a leaching system that includes additional filtration and drying as well as a mass balance table for major inputs and outputs in accordance with some embodiments disclosed herein.

FIG. 5 is a scanning electron micrograph of calcium hydroxide produced through precipitation of calcium from an acetate solution using sodium hydroxide in accordance with some embodiments disclosed herein.

FIG. 6 illustrates an exemplary schematic diagram of a two-stage leaching system for the feed material in accordance with some embodiments disclosed herein.

In the Figures, like reference numerals refer to like components unless otherwise stated herein.

### DETAILED DESCRIPTION

The following description sets forth exemplary compositions, materials, methods, systems, parameters and the like. It should be recognized, however, that such description is not intended as a limitation on the scope of the present disclosure but is instead provided as a description of exemplary embodiments.

Disclosed herein are systems and methods for extracting desired materials from industrial waste materials, byproducts, and/or natural minerals. Applicant has discovered improved leaching methods and systems that can reduce acid consumption and carbon dioxide emissions, thereby reducing costs and environmental impacts. Such methods can generate suitable pozzolanic materials for cement production and can generate concentrated streams of other sellable products such as magnesium hydroxide, iron oxides and hydroxides, and other high value metals (or their oxide or hydroxides) including manganese, chromium, and/or nickel to reduce waste and improve the economics of the extraction process.

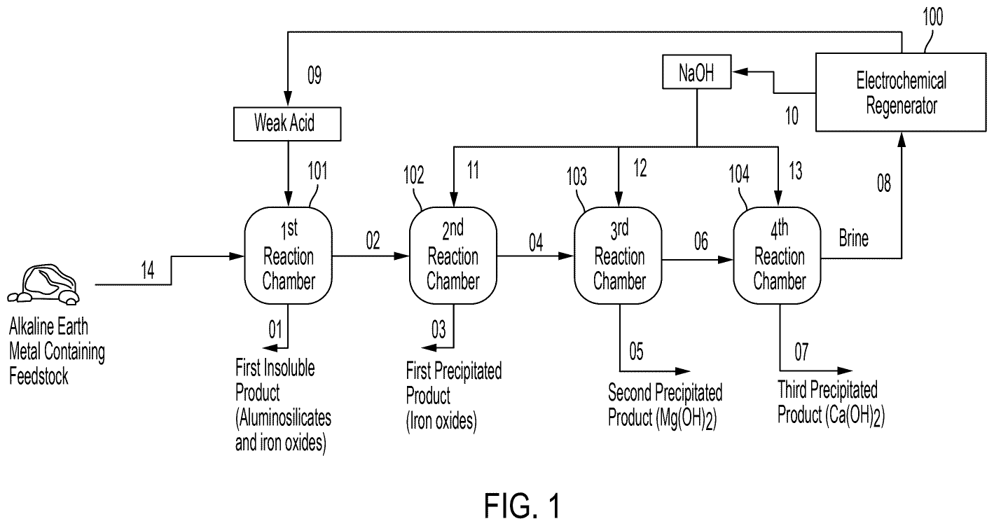

FIG. 1 is a schematic diagram of a leaching system with three precipitation steps and a corresponding leaching method process flow, according to various embodiments of the present disclosure. Referring to FIG. 1, the system may include an electrolyzer 100 or other electrochemical device such as an electrodialysis bipolar membrane system.

In some embodiments, the electrolyzer 100 may be configured to generate a weak acid and/or a base. A range of different electrochemical techniques can be used to generate and/or regenerate the acid and base for the systems and methods disclosed herein including bipolar membrane electrodialysis systems or electrolyzers. Electrolyzers that produce acids and/or bases, and systems that use said acids and/or bases for chemical dissolution and precipitation have been described in International Patent Application Nos. PCT/US2023/069007 (“Low Voltage Electrolyzer and Methods of Using Thereof”), filed Jun. 23, 2023, and PCT/US2023/073967 (“High Efficiency Acid-Base Leaching Methods and Systems”), filed Sep. 12, 2023, both of which are incorporated herein, in their entireties, by reference.

In some embodiments, the electrolyzer may generate a range of strong or weak acids. When digesting industrial wastes with high soluble metals concentration (as measured by sum of Fe₂O₃, CaO, MgO, and Al₂O₃ as measured by XRF) of greater than 40 wt. %, greater than 50 wt. %, or greater than 60 wt. %, it can be preferred to use a weaker acid such as monobasic phosphate, dibasic phosphate, bisulfate, bisulfite, acetic acid, formic acid, carbonic acid, citric acid, gluconic acid, tartaric acid, chloroacetic acid, dichloroacetic acid, trichloroacetic acid, and/or lactic acid. These acids can be advantageous over strong acids due to their ability to be generated at higher concentrations in either a bipolar membrane system or depolarized anode electrolyzer, the lack of need for an acid burner as required in chlor-alkali or nitric acid systems, and/or cheaper materials of construction. Additionally, the lack of an acid burner can reduce the amount of fresh water added to the system as the acid burner may require a downstream acid absorber where the combusted gas product (e.g., hydrochloric acid or nitric acid vapor) can be absorbed in water. When fresh water is added, it may necessitate removal somewhere else in the process at the cost of both energy and additional capital expenses.

Furthermore, weaker acids may dissolve significantly less iron and/or aluminum from a feed material. Not dissolving the iron and/or aluminum from iron and/or aluminum rich feeds, such as electric arc furnace slag or basic oxygen furnace slags can reduce the total demand of the electrolyzer and can reduce associated operational costs including energy and capital expenses due to a reduced electrolyzer size. For iron and/or aluminum rich materials that possess 10% or more iron and/or aluminum by mass, this can reduce acid demand by more than 10%, more than 20%, more than 30%, or more than 40% compared to a strong acid such as hydrochloric or nitric acids. In some embodiments, the amount of aluminum cations dissolved from the feed into the leachate may be less than 25 wt. % of the total aluminum, less than 10 wt. % of the total aluminum, less than 5 wt. % of the total aluminum, or less than 2% of the total aluminum of the feed material as measured by XRF of the feed material and ICP of the leachate or other suitable methods.

Where iron and/or aluminum is present in certain soluble phases, aluminum and/or iron may initially dissolve in the acid but then reprecipitate onto the solid within the reactor. This can form certain reactive aluminum phases such as boehmite, amorphous aluminum hydroxide, and/or amorphous aluminum oxyhydroxide that can contribute to rapid reactivity of the generated supplementary cementitious material (SCM). In some embodiments, the reactive aluminum phase content may be greater than 1 wt. %, greater than 2 wt. %, or greater than 5 wt. % of the supplementary cementitious material. In some embodiments, the reactive aluminum phase content may be less than 20 wt. %, less than 15 wt. %, or less than 10 wt. % of the supplementary cementitious material.

In some embodiments, the electrolyzer 100 may be configured to use electrochemical methods to generate a weak acid 09 and a base (e.g., strong base) 10 for subsequent leaching and/or alkaline metal precipitation. In some embodiments, the electrolyzer may operate using methods including hydrogen gas splitting, bipolar membrane electrodialysis, and/or chlor-alkali electrolysis. In some embodiments, the weak acid 09 may have a pH of 7 or less, a pH of 6 or less, a pH of 5 or less, a pH of 4.7 or less, a pH of 4 or less, or a pH of 3 or less. In some embodiments, the weak acid may have a pH of 2 or more, a pH of 3 or more, a pH of 4 or more, a pH of 5 or more, or a pH of 6 or more. In some embodiments, the weak acid may have a pH of about 2-7, about 3-6, about 3.5-5, about 4-5, or about 4.5-5. In some embodiments, the weak acid can include acetic acid, lactic acid, carbonic acid, bicarbonate, carbonates, benzoic acid, bisulfite, bisulfate, monobasic phosphate, dibasic phosphate, tribasic phosphate, citric acid, hydrofluoric acid, oxalic acid, sulfurous acid, etc., other weak acids capable of dissolving aluminum and/or iron, or combinations thereof. In some embodiments, the weak acid includes acetic acid (CH₃COOH), chloroacetic acid, dichloroacetic acid, trichloroacetic acid, formic acid (HCOOH), bisulfate (HSO₄—), bisulfite (HSO₃—), mono- or dibasic phosphate, carbonic acid (H₂CO₃), citric acid, hypochlorous acid, and/or lactic acid (CH₃CH(OH)COOH). In some embodiments, the pKa of the weak acid can be greater than or equal to 1, greater than or equal to 2, greater than or equal to 3, greater than or equal to 4, greater than or equal to 5, greater than or equal to 6, greater than or equal to 7, or greater than or equal to 8. In some embodiments, the pKa of the weak acid can be less than or equal to 11, less than or equal to 10, or less than or equal to 9. In some embodiments, the pKa of the weak acid can be 1-11, 2-11, 2-10, or 3-9. In some embodiments, the pKa of the weak acid can be less than 11 to dissolve calcium. In some embodiments, the pKa of the weak acid can be less than 9 to dissolve magnesium. In some embodiments, the pKa of the weak acid can be greater than 1 or greater than 3 to enable less expensive regeneration.

In some embodiments, base 10 may have a pH of greater than 10, a pH of greater than 11, a pH of greater than 12, a pH of greater than 13, or a pH of greater than 14. In some embodiments, the base may have a pH of 15 or less or 14 or less. In some embodiments, the base may have a pH ranging from about 14 to about 15. In some embodiments, the base can be a strong base. In some embodiments, the strong base can be sodium hydroxide, potassium hydroxide, lithium hydroxide, other alkali metal bases or alkaline earth metal bases or the like, other strong bases capable of precipitating aluminum, iron, magnesium, and/or calcium compounds (e.g., oxides and/or hydroxides), or combinations thereof. In some embodiments, the electrolyzer 100 may be configured such that the weak acid includes acetic acid (CH₃COOH), formic acid (HCOOH), carbonic acid (H₂CO₃), hypochlorous acid (HClO), and/or lactic acid (CH₃CH(OH)COOH) and the base includes sodium hydroxide (NaOH), potassium hydroxide (KOH), ammonium hydroxide, and/or other Lewis base or Bronsted-Lowry base with a pKb less than 7. In some embodiments, the base can have a pKb of less than or equal to 7, less than or equal to 6, less than or equal to 5, less than or equal to 4, less than or equal to 3, less than or equal to 2, or less than or equal to 1. For example, for magnesium precipitation, the pKb of the base can be less than 5, and for calcium precipitation the pKb of the base can be less than 3.

In some embodiments, the leaching system can include a reactor system that includes one or multiple reaction chambers. In some embodiments, the leaching system may include a first reaction chamber 101 (e.g., aluminosilicates and/or iron (oxides) reactor), a second reaction chamber 102 (e.g., iron reactor), a third reaction chamber 103 (e.g., magnesium reactor), and/or a fourth reaction chamber 104 (e.g., calcium reactor). In some embodiments, the reaction chambers may be settlement/leaching tanks or reactors, such as batch reactors, stirred-tank reactors, packed beds, etc. In some embodiments, a reaction chamber can be a portion of a larger reaction chamber. In some embodiments, the reaction chambers may be fluidly connected to one another and to the electrolyzer by conduits, pipes, manifolds, or the like. For example, the chambers 101, 102, 103, 104 may be fluidly connected to one another and to the electrolyzer 100 by conduits, pipes, manifolds, or the like. In some embodiments, the weak acid may be output from an acid outlet of an electrolyzer and provided to a first reaction chamber (e.g., for a dissolution/leaching reaction). For example, the weak acid 09 may be output from an acid outlet of the electrolyzer 100 and provided to the first reaction chamber 101. In some embodiments, the base may be output from a base outlet of an electrolyzer and sent to one or more reaction chambers (e.g., for a precipitation reaction). For example, the base 10 may be output from a base outlet of the electrolyzer 100 and sent to a second 102, third 103, and/or fourth 104 reaction chamber. In some embodiments, a salt or brine stream generated from one or more of the reaction chambers can be sent to the electrolyzer to regenerate the acid and/or base. For example, a salt or brine stream 08 (e.g., an aqueous solution containing an anion (e.g., acetate) of the weak acid) generated in a reaction chamber (e.g., fourth chamber 104) may be provided to a salt or brine inlet of the electrolyzer 100 and used to generate the acid 09 and/or the base 10. In some embodiments, these salt streams can have a pH greater than 7, a pH greater than 8, a pH greater than 9, a pH greater than 10, a pH greater than 11, or a pH greater than 12. In some embodiments, these salt streams can have a pH less than 14 or a pH less than 13. For example, the brine stream 08 may have a pH of about 7-13.

In some embodiments, a feed material 14 may be provided to one or more of the reaction chambers such as reaction chamber 101. In some embodiments, the feed material can include at least one of iron, magnesium, aluminum, calcium, or silicon, in addition to other metals such as transition metals. In some embodiments, the feed material can include at least two of iron, magnesium, aluminum, calcium, or silicon, in addition to other metals such as transition metals. In some embodiments, a feed material to a reaction chamber can include at least one alkaline earth metal. In some embodiments, a feed material can include ore, rock, slag, ash, minerals, tailing, byproduct, recycled concrete, industrial waste, etc., which may contain iron, silicon, aluminum, magnesium, and/or calcium materials, in addition to other metals and/or waste materials.

In some embodiments, industrial wastes and byproducts, such as slags, ashes, mining tailings, returned concrete, concrete demolition debris, and/or waste streams may be of environmental concern since weathering may result in leaching of various metals from such waste products. For example, red mud (i.e., bauxite residue), is a waste product generated during the processing of bauxite into alumina using the Bayer process and may include various oxide or hydroxide compounds, such as iron oxide (Fe₂O₃ and/or FeO), iron hydroxide (Fe(OH)₂ and/or Fe(OH)₃) aluminum oxide (Al₂O₃), aluminum hydroxide (Al(OH)₃), titanium dioxide TiO₂, calcium oxide (CaO), silicon dioxide (SiO₂), and/or sodium oxide (Na₂O). Slag can be a byproduct of metal ore smelting that may include silicon oxide and other metal oxides such as calcium oxide, magnesium oxide, iron oxide, and/or aluminum oxide. Electric arc furnace (EAF) slag, basic oxygen furnace (BOF) slag, and ladle slag can be generated during steelmaking and difficult to use as a supplementary cementitious material for cement and concrete. Fly ash, bottom ash, and/or ponded ash can be a coal combustion product that may contain silicon dioxide (amorphous and crystalline), aluminum oxide, iron oxide, and/or calcium oxide as primary components, depending on the type of combusted coal. Other combustion ashes derived from the combustion of other solid fuels such as biomass or municipal waste may have similar properties to those of coal ashes. In some embodiments, ores and naturally occurring minerals that may be leached include silicates such as wollastonite, olivine, serpentine, basalt, gabbro, amphibolite, anorthite, anorthosite, allanite, allanite ores, limestone, dolomitic limestone, feldspars including plagioclase feldspars and other silicates that may incorporate calcium, magnesium, iron, aluminum, platinum group elements, and/or rare earth elements. Similarly, aluminosilicates incorporating calcium, magnesium, iron, platinum group elements, and/or rare earth elements may also be leached. Carbonates of calcium and/or magnesium may also be leached. Ores and minerals can also include mafic or ultramafic rocks. In some embodiments, clays such as kaolin or bentonite, may also be suitable feedstocks or feed materials. Any and/or all of the above, can be a feed material for one or more reaction chambers of the systems and methods disclosed herein.

In some embodiments, the feed material can have a particularly high iron content that may be greater than about 10 wt. %, greater than about 20 wt. %, greater than 30 wt. %, or greater than about 40 wt. %. Because of their high iron content, leaching EAF, BOF, or ladle slag with a strong acid may require significantly more acid than when leached with a weak acid. In some embodiments, leaching coal and other combustion ashes with a weak acid can provide similar reductions in acid use and improvements in filtration and drying as with slag. In some embodiments, the reduction of acid consumption with a weak acid instead of a strong acid could be more than about 10%, more than about 20%, more than about 30%, or more than about 40%. In some embodiments, leaching a feed material with a weak acid can produce an insoluble product (e.g., stream 01) that is easier filter and with a lower moisture content that can reduce drying expenses. For example, when an aggressive acid is used for leaching, the chemical reactions can occur very quickly and form chaotic amorphous silica and alumina gels that have very low density and are very hydroscopic. In contrast, when leaching with a weak acid, everything can happen more slowly and there can tend to be an avoidance of the rapid gelling in favor of leaving the aluminum and silica in much denser states. In some embodiments, when leached with a weak acid, the filtration rate of the generated slurry can be greater than 0.1 g/min/cm², greater than 0.5 g/min/cm², or greater than 1.0 g/min/cm² of filtration area when using a Buchner funnel with a vacuum pressure of at least 15 inches of mercury and a cake thickness of greater than 4 mm and with a filter paper pore size ranging from 2-14 micrometers. In some embodiments, when leached with a weak acid, the moisture content of a wet filter cake of the insoluble product after leaching may be less than 75 wt. %, less than 60 wt. %, less than 50 wt. %, or less than 40 wt. %. Additionally, the leachate stream resulting from a weak acid leaching can have a higher proportion of cations that include calcium and/or magnesium. The amount of calcium and/or magnesium ions of all cations leached may be greater than 40 wt. %, greater than 60 wt. %, greater than 80 wt. %, or greater than 90 wt. %.

In some embodiments, many industrial wastes such as slags also possess high-value transition metals including manganese, nickel, chromium, and/or molybdenum metals and/or salts. As such, in some embodiments, the feed material can include transition metals or metal salts such as manganese, nickel, chromium, and/or molybdenum. Although present in smaller quantities compared to other base metals, some of these trace metals such as manganese, chromium, and/or nickel have been declared as critical minerals according to the 2023 DOE Critical Materials List, determined by the U.S. Geological Survey. Although not deemed a critical mineral, molybdenum can be a key component in alloying to create strong, durable, and/or corrosion resistant metals, particularly for engines. Thus, due to their importance as critical minerals for energy and national defense, selectively extracting even small traces of these elements from the metal salt solution and converting them into saleable products can greatly improve the economics of the entire leaching process.

In some embodiments, these critical minerals can be leached from the feed material in the first acid digestion. The process stream or leachate including the dissolved metal salts can be processed to extract the high-value transition metals through a range of different known extraction technologies that are used at industrial scales, including direct electrowinning in the solution, extraction via liquid-liquid separation with a selective solvent, and/or removal via ion-exchange resins. Electrowinning can produce individual metals directly onto electrodes submersed in the aqueous solution, determined by applied voltage and current. Liquid-liquid extraction (also known as solvent extraction) can utilize a non-aqueous or organic solvent that, when mixed into the aqueous solution, can selectively extract critical mineral ions, depending on the type of extractant used. Similarly, the aqueous solution of metal salts can be passed though columns of ion exchange resin, which can also selectively bind to desired elements over others. If separated via liquid-liquid separation or ion exchange resins, the extracted cations may then be released separately from the non-aqueous solvent or ion exchange resin in different aqueous streams where they may be reduced to their metallic form or precipitated. Any of these extractions may be performed before or after one or more precipitation steps disclosed herein, such that competing cations such as iron (III), iron (II), and/or magnesium are removed prior to the extraction. This flexibility of the separation process can enable more complete separation and higher purities of valuable transition metals extracted from the mother solution of metal salts.

In some embodiments, a feed material may be provided or supplied to a first reaction chamber where it can react with a weak acid. In some embodiments, the weak acid (and/or bases disclosed herein) can be supplied from a weak acid source (and/or base source). In some embodiments, the weak acid (and/or bases disclosed herein) can be added or provided from commercially available source or produced in situ. In some embodiments, the amount of weak acid used (i.e., amount of weak acid used to process the feed material) is between 80% and 120% of the stoichiometric amount required to dissolve all the calcium oxide in the feed material as measured by XRF and assuming two moles of acid are required per mole of calcium oxide. In some embodiments, the amount of weak acid used is at least about 75%, at least about 80%, at least about 85%, at least about 90%, at least about 95%, at least about 100%, at least about 105%, at least about 110%, or at least about 115% of the stoichiometric amount required to dissolve all the calcium oxide in the feed material as measured by XRF and assuming two moles of acid are required per mole of calcium oxide. In some embodiments, the amount of weak acid used is at most about 125%, at most about 120%, at most about 115%, at most about 110%, at most about 105%, at most about 100%, at most about 95%, at most about 90%, or at most about 85% of the stoichiometric amount required to dissolve all the calcium oxide in the feed material as measured by XRF and assuming two moles of acid are required per mole of calcium oxide.

In some embodiments, the amount of weak acid used (i.e., amount of weak acid used to process the feed material) is between 80% and 120% of the stoichiometric amount required to dissolve all the calcium oxide and magnesium oxide in the feed material as measured by XRF and assuming two moles of acid are required per mole of calcium oxide and two moles of acid are required per mole of magnesium oxide. In some embodiments, the amount of weak acid used is at least about 75%, at least about 80%, at least about 85%, at least about 90%, at least about 95%, at least about 100%, at least about 105%, at least about 110%, or at least about 115% of the stoichiometric amount required to dissolve all the calcium oxide and magnesium oxide in the feed material as measured by XRF and assuming two moles of acid are required per mole of calcium oxide and two moles of acid are required per mole of magnesium oxide. In some embodiments, the amount of weak acid used is at most about 125%, at most about 120%, at most about 115%, at most about 110%, at most about 105%, at most about 100%, at most about 95%, at most about 90%, or at most about 85% of the stoichiometric amount required to dissolve all the calcium oxide and magnesium oxide in the feed material as measured by XRF and assuming two moles of acid are required per mole of calcium oxide and two moles of acid are required per mole of magnesium oxide.

In some embodiments, it is desirable to maintain the amount of weak acid required to process the feed material to below 25 moles of weak acid per kg of feed material, below 20 moles of weak acid per kg of feed material, below 15 moles of weak acid per kg of feed material, below 12 moles of weak acid per kg of feed material, or below 10 moles of weak acid per kg of feed material. In some embodiments, the amount of weak acid required to process the feed material can be greater than 1 mole of weak acid per kg of feed material, greater than 5 moles of weak acid per kg of feed material, or greater than 10 moles of weak acid per kg of feed material. In some embodiments, the amount of weak acid per kg of feed material can be about 1-25, about 1-20, or about 1-15 moles of weak acid per kg of feed material. When leaching with a strong acid (e.g., hydrochloric acid), many highly soluble slags require greater than 30 moles of acid per kg of feed material. In some embodiments, it is desirable to maximize the efficiency of leaching the alkaline earth metals and dissolve more than 80% of the alkaline earth metals in the first reaction chamber while at least 50% of the iron and/or aluminum (or more than 75%, more than 80%, more than 85%, more than 90%, or more than 95% of the iron and/or aluminum) from the feed material can leave the acid dissolution in the insoluble product and therefore not consume acid. Many feed materials can contain a combination of oxides, hydroxides, and carbonates of silicon, aluminum, iron, magnesium, and/or calcium along with lower concentration of valuable metals including manganese, nickel, chromium, and/or molybdenum. To extract the greatest economic value from these elements, it may be beneficial to extract high purity components that command the greatest economic value.

In some embodiments, a first leachate or process stream can be generated in the first reaction chamber by the reaction of the feed material with a weak acid. For example, a first leachate or process stream 02 can be generated in the first reaction chamber 101. The first leachate or process stream may be a liquid fraction or leachate including at least a metal cation (e.g., iron material). In some embodiments, the first leachate or process stream can include ions of at least one metal (or at least two metals) in the feed material. In some embodiments, the first leachate or process stream may include a calcium salt, magnesium salt, and/or other metal salts.

In some embodiments, calcium cations make up at least about 75 wt. %, at least about 80 wt. %, at least about 85 wt. %, or at least about 90 wt. % of all leached cations in the first leachate or process stream as measured using inductively coupled plasma atomic emission spectroscopy (ICP-AES). In some embodiments, calcium cations make up at most about 99.9 wt. %, at most about 99 wt. %, at most about 98 wt. %, at most about 96 wt. %, or at most about 95 wt. % of all leached cations in the first leachate or process stream as measured using inductively coupled plasma atomic emission spectroscopy (ICP-AES). In some embodiments, calcium and magnesium cations make up at least about 75 wt. %, at least about 80 wt. %, at least about 85 wt. %, at least about 90 wt. %, at least about 93 wt. %, or at least about 95 wt. % of all leached cations in the first leachate or process stream as measured using inductively coupled plasma atomic emission spectroscopy (ICP-AES). In some embodiments, calcium and magnesium cations make up at most about 99.9 wt. %, at most about 99 wt. %, at most about 98 wt. %, or at most about 96 wt. % of all leached cations in the first leachate or process stream as measured using inductively coupled plasma atomic emission spectroscopy (ICP-AES). These weight percentages can provide the selectivity for calcium or calcium and magnesium versus all other cations that could have potentially been leached by the acid. For example, by having 90+% being calcium (or calcium and magnesium), that means that there is not much iron and/or aluminum being leached with can be advantageous since it can reduce acid consumption and/or eases making pure calcium and/or magnesium streams.

In some embodiments, reacting the feed material with the weak acid can also produce an insoluble product. In other words, components of the feed material that are not dissolvable with the weak acid can be in the first insoluble product 01 (e.g., aluminosilicates and/or iron oxides). In some embodiments, the insoluble product can be an output from a first reaction chamber. In some embodiments, the first insoluble product can be an SCM, siliceous material, and/or a pozzolan product. In some embodiments, a pozzolan product (e.g., a component containing silicon such as silicas, silicates, and/or aluminosilicates) may be an output from the first reaction chamber. In some embodiments, the pozzolan product may be a solids fraction that can include precipitated silicas, silicates, and/or aluminosilicates as a primary component. In some embodiments, the insoluble product (e.g., the SCM, siliceous material, or pozzolan product) may be collected and stored in a suitable container.

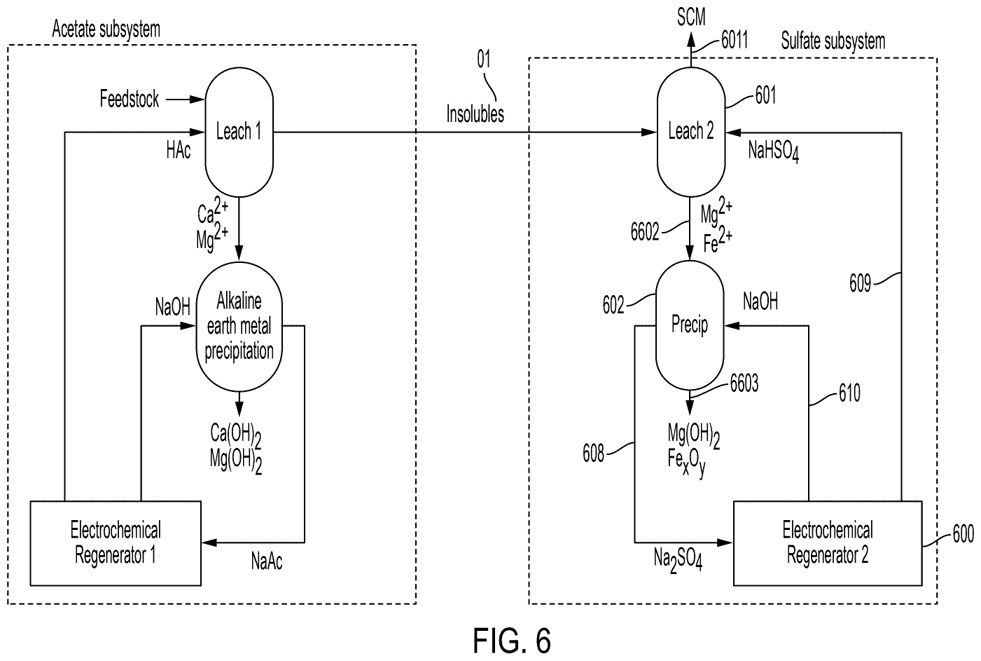

In some embodiments, the insoluble product may undergo a second leaching to extract additional elements and/or improve the properties of the insoluble product as a supplementary cementitious material (SCM), siliceous material, or pozzolan. For example, FIG. 6 illustrates an exemplary schematic diagram of a two-stage leaching system for the feed material in accordance with some embodiments disclosed herein. As shown in FIG. 6, the acetate subsystem can refer to any of the systems or portions of systems illustrated in FIGS. 1-3 where a weak acid leaches a feed material and at least one component is precipitated. For example, the Leach 1 can refer to the first reaction chamber 101 of any one of FIGS. 1-3 and Alkaline earth metal precipitation chamber of FIG. 6 can be any one or more of reaction chambers 102, 103, and 104 of FIGS. 1-3. In some embodiments, a leachate or process stream can be generated in the reaction chamber (Leach 1) by the reaction of the feed material with a weak acid. For example, a first leachate or process stream can be generated in a reaction chamber (e.g., Leach 1). In some embodiments, the leachate or process stream can include ions of at least one metal (or at least two metals such as calcium and magnesium) in the feed material. In some embodiments, the leachate or process stream may include a calcium salt, magnesium salt, and/or other salts of leached metals.

Referring to FIG. 6, the system may include an electrolyzer 600 or other electrochemical device such as an electrodialysis bipolar membrane system. In some embodiments, the electrolyzer 600 may be configured to generate a second acid and/or a base. A range of different electrochemical techniques can be used to generate and/or regenerate the acid and base for the systems and methods disclosed herein including bipolar membrane electrodialysis systems or electrolyzers.

In some embodiments, the electrolyzer 600 may generate a range of strong or weak acids. In some embodiments, the electrolyzer 600 may be configured to use electrochemical methods to generate an acid 609 and a base (e.g., strong base) 610 for subsequent leaching and/or metal precipitation. In some embodiments, the acid and/or base used in the second leaching of the insoluble product 01 and/or precipitation of any leachate materials from this second leaching can be from the first electrolyzer 100. In some embodiments, the electrolyzer may operate using methods including hydrogen gas formation and/or consumption, bipolar membrane electrodialysis, and/or chlor-alkali electrolysis.

In some embodiments, the insoluble product may undergo a second leaching with a different acid than the first leaching acid. In some embodiments, the acid 609 can be a stronger acid than the first leaching acid of the feed material. In some embodiments, the insoluble product may undergo a second leaching with a different acid with a lower pH and/or lower pKa than the first leaching acid. In some embodiments, the second leaching acid 609 may have a pH of 7 or less, a pH of 6 or less, a pH of 5 or less, a pH of 4.7 or less, a pH of 4 or less, or a pH of 3 or less. In some embodiments, the second leaching acid may have a pH of 2 or more, a pH of 3 or more, a pH of 4 or more, a pH of 5 or more, or a pH of 6 or more. In some embodiments, the second leaching acid may have a pH of about 2-7, about 3-6, about 3.5-5, about 4-5, or about 4.5-5. In some embodiments, the second leaching acid can include nitric acid, sulfuric acid, hydrochloric acid, perchloric acid, hypochlorous acid, acetic acid, lactic acid, carbonic acid, bicarbonate, carbonates, benzoic acid, bisulfite, bisulfate, monobasic phosphate, dibasic phosphate, tribasic phosphate, citric acid, hydrofluoric acid, oxalic acid, sulfurous acid, etc., or combinations thereof. In some embodiments, the second leaching acid includes acetic acid (CH₃COOH), chloroacetic acid, dichloroacetic acid, trichloroacetic acid, formic acid (HCOOH), bisulfate (HSO₄—), bisulfite (HSO₃—), mono- or dibasic phosphate, carbonic acid (H₂CO₃), citric acid, hypochlorous acid, and/or lactic acid (CH₃CH(OH)COOH). In some embodiments, the second leaching acid can have a pKa less than the first leaching acid. In some embodiments, the pKa of the second leaching acid can be less than the pKa of the first leaching acid by at least 1 pKa unit, at least 2 pKa units, or at least 3 pKa units. In some embodiments, the pKa of the second leaching acid can be less than or equal to 9, less than or equal to 8, less than or equal to 7, less than or equal to 6, less than or equal to 5, less than or equal to 4, less than or equal to 3, less than or equal to 2, or less than or equal to 1. For example, in some embodiments, the pKa of the second leaching acid can be below 9 if intended to extract magnesium. In some embodiments, the pKa of the second leaching acid can be greater than or equal to 1.

In some embodiments, base 610 may have a pH of greater than 10, a pH of greater than 11, a pH of greater than 12, a pH of greater than 13, or a pH of greater than 14. In some embodiments, the base may have a pH of 15 or less or 14 or less. In some embodiments, the base may have a pH ranging from about 14 to about 15. In some embodiments, the base can be a strong base. In some embodiments, the strong base can be sodium hydroxide, potassium hydroxide, lithium hydroxide, other alkali metal bases or alkaline earth metal bases or the like, other strong bases capable of precipitating aluminum, iron, magnesium, and/or calcium compounds (e.g., oxides and/or hydroxides), or combinations thereof. In some embodiments, the electrolyzer 600 may be configured such that the second leaching acid includes acetic acid (CH₃COOH), formic acid (HCOOH), carbonic acid (H₂CO₃), hypochlorous acid, and/or lactic acid (CH₃CH(OH)COOH) and the base includes sodium hydroxide (NaOH), potassium hydroxide (KOH), ammonium hydroxide, and/or other Lewis base or Bronsted-Lowry base with a pKb less than 9 or less than 7. In some embodiments, the base can have a pKb of less than or equal to 9, less than or equal to 8, less than or equal to 7, less than or equal to 6, less than or equal to 5, less than or equal to 4, less than or equal to 3, less than or equal to 2, or less than or equal to 1.

In some embodiments, the second leaching system (shown in FIG. 6 as sulfate subsystem) can include a reactor system that includes one or multiple reaction chambers. In some embodiments, the second leaching system may include a reaction chamber 601 (e.g., Leach 2 reactor) and/or at least one second reaction chamber 602 (e.g., Precip). In some embodiments, the reaction chambers may be settlement/leaching tanks or reactors, such as batch reactors, stirred-tank reactors, packed beds, etc. In some embodiments, the reaction chambers may be fluidly connected to one another and to any electrolyzer by conduits, pipes, manifolds, or the like. For example, the chambers 601 and 602 may be fluidly connected to one another and to the electrolyzer 600 by conduits, pipes, manifolds, or the like. In some embodiments, the acid may be output from an acid outlet of an electrolyzer and provided to a reaction chamber (e.g., for a dissolution/leaching reaction). For example, the acid 609 may be output from an acid outlet of the electrolyzer 600 and provided to the reaction chamber 601. In some embodiments, the base may be output from a base outlet of an electrolyzer and sent to one or more reaction chambers (e.g., for a precipitation reaction). For example, the base 610 may be output from a base outlet of the electrolyzer 600 and sent to a reaction chamber 602. In some embodiments, a salt or brine stream generated from one or more of the reaction chambers can be sent to the electrolyzer to regenerate the acid and/or base. For example, a salt or brine stream 608 (e.g., an aqueous solution containing an anion) generated in a reaction chamber (e.g., chamber 602) may be provided to a salt or brine inlet of the electrolyzer 600 and used to generate the acid 609 and/or the base 610. In some embodiments, these salt streams can have a pH greater than 4, a pH greater than 6, a pH greater than 8, a pH greater than 10, a pH greater than 11, or a pH greater than 12. In some embodiments, these salt streams can have a pH less than 14 or a pH less than 11. For example, the brine stream 608 may have a pH of about 4-13.

In some embodiments, a first insoluble product 01 may be provided to one or more of the reaction chambers such as reaction chamber 601. In some embodiments, when leached with another acid, the moisture content of a wet filter cake of the second insoluble product after this second leaching may be less than 50 wt. %. This second leaching can improve the reactivity of the second insoluble product as a pozzolanic material. Performing the second leach can increase the pozzolanic reactivity of the insoluble product as measured by the R3 test described in ASTM C1897 by more than 25 J/g SCM, more than 50 J/g SCM, more than 100 J/g SCM, or more than 150 J/g SCM. In some embodiments, performing the second leach can increase the pozzolanic reactivity of the insoluble product as measured by the R3 test described in ASTM C1897 by less than 1000 J/g SCM, less than 500 J/g SCM, or less than 250 J/g SCM.

In some embodiments, a first insoluble product may be provided or supplied to a first reaction chamber where it can react with an acid. In some embodiments, it is desirable to maintain the amount of acid required to process the first insoluble product to below 12 moles of acid per kg of first insoluble product. In some embodiments, it is desirable to maximize the efficiency of leaching the magnesium, manganese, and/or iron and dissolve more than 80% of the magnesium, manganese, and/or iron in the second leaching reaction chamber while at least 50% of the aluminum, and preferably more than 75% of the aluminum, from the first insoluble product can leave the acid dissolution in the second insoluble product and therefore not consume acid.

In some embodiments, a leachate or process stream can be generated in the reaction chamber by the reaction of the first insoluble product with an acid. For example, a leachate or process stream 6602 can be generated in the reaction chamber 601. The leachate or process stream may be a liquid fraction or leachate including at least a metal cation (e.g., magnesium, iron, aluminum, and/or manganese). In some embodiments, the leachate or process stream can include ions of at least one metal (or at least two metals) in the first insoluble product. In some embodiments, the leachate or process stream may include an iron salt, magnesium salt, aluminum salt, manganese salt, and/or other metal salts. In some embodiments, reacting the first insoluble product with the acid can also produce a second insoluble product 6011. In other words, components of the first insoluble product that are not dissolvable with the acid can be in the second insoluble product 6011 (e.g., aluminosilicates). In some embodiments, the second insoluble product can be an output from the reaction chamber. In some embodiments, the second insoluble product can be an SCM, siliceous material, and/or a pozzolan product. In some embodiments, a pozzolan product (e.g., a component containing silicon such as silicas, silicates, and/or aluminosilicates) may be an output from the reaction chamber. In some embodiments, the pozzolan product may be a solids fraction that can include precipitated silicas, silicates, and/or aluminosilicates as a primary component. In some embodiments, the second insoluble product (e.g., the SCM, siliceous material, or pozzolan product) may be collected and stored in a suitable container.

In some embodiments, the amount of acid used (i.e., amount of acid used to process the first insoluble product) is between 25% and 100% of the stoichiometric amount required to dissolve all the iron oxide, manganese oxide, and magnesium oxide in the first insoluble product as measured by XRF and assuming two moles of acid are required per mole of iron oxide, two moles of acid are required per mole of manganese oxide, and two moles of acid are required per mole of magnesium oxide. In some embodiments, the amount of acid used is at least about 25%, at least about 35%, at least about 45%, at least about 65%, at least about 75%, at least about 85%, at least about 90%, at least about 95%, or at least about 100% of the stoichiometric amount required to dissolve all the iron oxide, manganese oxide, and magnesium oxide in the first insoluble product as measured by XRF and assuming two moles of acid are required per mole of iron oxide, two moles of acid are required per mole of manganese oxide, and two moles of acid are required per mole of magnesium oxide. In some embodiments, the amount of acid used is at most about 90%, at most about 80%, at most about 70%, at most about 60%, at most about 50%, at most about 40%, at most about 30%, or at most about 25% of the stoichiometric amount required to dissolve all the iron oxide, manganese oxide, and magnesium oxide in the first insoluble product as measured by XRF and assuming two moles of acid are required per mole of iron oxide, two moles of acid are required per mole of manganese oxide, and two moles of acid are required per mole of magnesium oxide. In some embodiments, iron, manganese, and magnesium cations make up at least about 40 wt. %, at least about 45 wt. %, at least about 50 wt. %, at least about 55 wt. %, at least about 60 wt. %, at least about 65 wt. %, at least about 70 wt. %, at least about 80 wt. %, or at least about 85 wt. % of all leached cations in the leachate or process stream from leaching the insoluble product twice as measured using inductively coupled plasma atomic emission spectroscopy (ICP-AES). In some embodiments, iron, manganese, and magnesium cations make up at most about 99.99 wt. %, at most about 99 wt. %, at most about 98 wt. %, at most about 95 wt. %, or at most about 90 wt. % of all leached cations in the leachate or process stream from leaching the insoluble product twice as measured using inductively coupled plasma atomic emission spectroscopy (ICP-AES).

### First and Second (Twice Leached) Insoluble Products (Siliceous Materials, SCMs, or Pozzolans

Siliceous materials may constitute an important component in many materials, including cementitious construction materials such as cements, cement mortars, and concretes. In these applications, the properties of the siliceous materials used, especially their reactivity and flowability, can be critical to the functionality of the resulting products. In some embodiments, the first insoluble product and/or second insoluble product are siliceous materials, SCMs, or pozzolan that may be used as an additive or component to cement, concrete, and/or related construction and building materials.

For example, in the manufacture of portland cement, the reactivity of lime and silica during high temperature firing can be important to the energy-efficient production of clinker with desired properties. For pozzolanic cements, the reactivity of the pozzolan, which is the primary siliceous phase of matter used, can be critical to the development of properties during hydration and reaction. For supplemental cementitious materials (SCMs) such as fly ashes and ground granulated blast furnace slags, the reactivity of the SCM in the cementitious mixture can be a key selection criterion. In mortars and in concrete, the reactivity of the non-cement paste materials, such as sand, gravel, and aggregate, can affect the bonding between the cement paste and the aggregate. Many siliceous materials have not found widespread use in cement and concrete due to their insufficient reactivity, despite their low cost and abundance. For example, while fly ash from coal-fired power plants is widely used as an SCM, bottom ash is not, largely due to its limited reactivity. As another example, clays can typically be calcined in order to increase their reactivity for use in cements.

Likewise, the flowability of a siliceous material can also be important because minimizing the amount of added water in the final product can be critical for ensuring high strength and fast reactivity of calcium silicate hydrate (C—S—H) formation. In some embodiments and applications, different siliceous materials may require variable amounts of water to achieve the appropriate flowability.

A pozzolan is typically a silicate or aluminosilicate material (e.g., mineral), either naturally occurring or synthesized (man-made). It may be any silicate-bearing material that is capable of reacting with lime to set and harden, with or without the presence of water, to form a cement or concrete. In some embodiments, lime as described herein may react with said pozzolan and water in a “pozzolanic reaction” that creates calcium silicate hydrate as a hydration product. Said reaction may also create other hydrated phases including, but not limited to, calcium aluminum silicate hydrate and/or sodium aluminum silicate hydrate phases.

One or more types of pozzolan may be used in a cement composition. Specific natural or artificial pozzolans that may be used in this cement composition include: slag (blast furnace slag, steel slag, basic oxygen furnace slag), coal ash (fly ash Class C and F, bottom ash, economizer ash, ponded ash), municipal solid waste incinerator ash, silica fume, raw clay, calcined clay, calcined shale, metakaolin, volcanic tuffs, moler, gaize, ground pumice, diatomaceous earths, biomass ash (rice husk ash, sugar cane ash), ground glass, and halloysite. The pozzolan may be in the form of solid particles with major diameters between 1 nm and 1 mm. In some embodiments, the pozzolan particle's major diameter range may be 500 nm-30 micron. The pozzolan may comprise a dry powder, a suspension of pozzolan particles in water, or in an aqueous solution such as in a sodium hydroxide solution. In some embodiments, the cement blend can contain at least 1% by mass of the pozzolan. In some embodiments, the cement blend may contain 10-80% by mass of pozzolan.

In some embodiments, the first and/or second (i.e., twice leached) insoluble product (i.e., siliceous material, supplementary cementitious material (SCM), or pozzolan) may have one or more of the following attributes, including combinations and variations of the following:
Specific surface area of at least 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, or 1000 m²/g as measured using a Brunauer-Emmett-Teller (BET) technique;
Specific surface area of less than 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, or 1000 m²/g as measured using a Brunauer-Emmett-Teller (BET) technique;
A micropore volume and/or a Barrett, Joyner and Halenda (BJH) pore volume of at least 0.01 mL/g, 0.02 mL/g, 0.03 mL/g, 0.04 mL/g, 0.05 mL/g, 0.06 mL/g, 0.07 mL/g, 0.08 mL/g, 0.09 mL/g, 0.10 mL/g, 0.11 mL/g, 0.12 mL/g, 0.13 mL/g, 0.14 mL/g, 0.15 mL/g, 0.16 mL/g, 0.17 mL/g, 0.18 mL/g, 0.19 mL/g, 0.20 mL/g, 0.25 mL/g, 0.30 mL/g, 0.40 mL/g, 0.50 mL/g, 0.60 mL/g, 0.70 mL/g, 0.80 mL/g, 0.90 mL/g, 1.00 mL/g, 1.2 mL/g, 1.4 mL/g, 1.6 mL/g, 1.8 mL/g, 2 mL/g, 3 mL/g, 4 mL/g, 5 mL/g, 6 mL/g, 7 mL/g, 8 mL/g, 9 mL/g, 10 mL/g, 20 mL/g, 30 mL/g, 40 mL/g, or 50 mL/g as measured using a Brunauer-Emmett-Teller (BET) technique;
A micropore volume and/or a Barrett, Joyner and Halenda (BJH) pore volume of less than 0.01 mL/g, 0.02 mL/g, 0.03 mL/g, 0.04 mL/g, 0.05 mL/g, 0.06 mL/g, 0.07 mL/g, 0.08 mL/g, 0.09 mL/g, 0.10 mL/g, 0.11 mL/g, 0.12 mL/g, 0.13 mL/g, 0.14 mL/g, 0.15 mL/g, 0.16 mL/g, 0.17 mL/g, 0.18 mL/g, 0.19 mL/g, 0.20 mL/g, 0.25 mL/g, 0.30 mL/g, 0.40 mL/g, 0.50 mL/g, 0.60 mL/g, 0.70 mL/g, 0.80 mL/g, 0.90 mL/g, 1.00 mL/g, 1.2 mL/g, 1.4 mL/g, 1.6 mL/g, 1.8 mL/g, 2 mL/g, 3 mL/g, 4 mL/g, 5 mL/g, 6 mL/g, 7 mL/g, 8 mL/g, 9 mL/g, 10 mL/g, 20 mL/g, 30 mL/g, 40 mL/g, or 50 mL/g as measured using a Brunauer-Emmett-Teller (BET) technique;
Blaine fineness (air-permeability specific surface area) of at least 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, 800 m²/g, 900 m²/g, 1000 m²/g, 1100 m²/g, 1200 m²/g, 1400 m²/g, 1600 m²/g, 1800 m²/g, or 2000 m²/g as measured using the method and apparatus described in ASTM C204: Test Methods for Fineness of Hydraulic Cement by Air-Permeability Apparatus;
Blaine fineness (air-permeability specific surface area) of less than 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, 800 m²/g, 900 m²/g, 1000 m²/g, 1100 m²/g, 1200 m²/g, 1400 m²/g, 1600 m²/g, 1800 m²/g, or 2000 m²/g as measured using the method and apparatus described in ASTM C204: Test Methods for Fineness of Hydraulic Cement by Air-Permeability Apparatus;
Average roughness factor of less than 1.1, 1.2, 1.3, 1.5, 1.75, 2, 2.5, 3, 4, 5, 6, 7, 8, 9, 10, 15, 20, 25, 30, 40, 50, 60, 70, 80, 90, or 100, where roughness factor is defined as the quotient of a particle's actual surface area to volume ratio to the surface area to volume ratio expected for a sphere having the same volume as the actual particle;
Average primary particle diameter of at least 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Average primary particle diameter of less than 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Narrow particle size distribution, as defined by having at least 50%, 60%, 70%, 80%, 90%, 95%, or 99% of all particles by count or by mass within a diameter range having a width of less than 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Wide particle size distribution, as defined by having at least 50%, 60%, 70%, 80%, 90%, 95%, or 99% of all particles by count or by mass within a diameter range having a width of at least 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Minimum aspect ratio of all particles, defined as the ratio of the primary particle's largest linear dimension to the primary particle's smallest dimension, of at least 1, 1.05, 1.1, 1.2, 1.3, 1.5, 1.7, 2, 2.5, 3, 4, 5, 6, 7, 8, 9, 10, 15, 20, 25, 30, 40, or 50;
Average aspect ratio of all particles, defined as the ratio of the primary particle's largest linear dimension to the primary particle's smallest dimension, of at least 1, 1.05, 1.1, 1.2, 1.3, 1.5, 1.7, 2, 2.5, 3, 4, 5, 6, 7, 8, 9, 10, 15, 20, 25, 30, 40, or 50;
Minimum aspect ratio of all particles, defined as the ratio of the primary particle's largest linear dimension to the primary particle's smallest dimension, of less than 1.05, 1.1, 1.2, 1.3, 1.5, 1.7, 2, 2.5, 3, 4, 5, 6, 7, 8, 9, 10, 15, 20, 25, 30, 40, or 50;
Average aspect ratio of all particles, defined as the ratio of the primary particle's largest linear dimension to the primary particle's smallest dimension, of less than 1.05, 1.1, 1.2, 1.3, 1.5, 1.7, 2, 2.5, 3, 4, 5, 6, 7, 8, 9, 10, 15, 20, 25, 30, 40, or 50;
Specific surface area to major diameter ratio of at least 0.1 (m²/g)/micron, 0.2 (m²/g)/micron, 0.3 (m²/g)/micron, 0.5 (m²/g)/micron, 0.7 (m²/g)/micron, 1 (m²/g)/micron, 3 (m²/g)/micron, 5 (m²/g)/micron, 7 (m²/g)/micron, 10 (m²/g)/micron, 20 (m²/g)/micron, 30 (m²/g)/micron, 40 (m²/g)/micron, 50 (m²/g)/micron, 70 (m²/g)/micron, or 100 (m²/g)/micron;
Specific surface area to major diameter ratio of less than 0.1 (m²/g)/micron, 0.2 (m²/g)/micron, 0.3 (m²/g)/micron, 0.5 (m²/g)/micron, 0.7 (m²/g)/micron, 1 (m²/g)/micron, 3 (m²/g)/micron, 5 (m²/g)/micron, 7 (m²/g)/micron, 10 (m²/g)/micron, 20 (m²/g)/micron, 30 (m²/g)/micron, 40 (m²/g)/micron, 50 (m²/g)/micron, 70 (m²/g)/micron, or 100 (m²/g)/micron;
An apparent packed density of less than about 1.0, 1.1, 1.2, 1.3, 1.4, 1.5, 1.6, 1.7, 1.8, 1.9, 2.0, 2.1, 2.2, 2.3, 2.4, or 2.5 grams per mL as measured by the method in ASTM C110 or a similar method;
An apparent packed density of at least 1.0, 1.1, 1.2, 1.3, 1.4, 1.5, 1.6, 1.7, 1.8, 1.9, 2.0, 2.1, 2.2, 2.3, 2.4, or 2.5 grams per mL as measured by the method in ASTM C110 or a similar method;
A true density or skeletal density of less than about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 grams per mL;
A true density or skeletal density of at least 11.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 grams per mL;
Purity of at least 80%, 82%, 84%, 86%, 88%, 90%, 92%, 94%, 95%, 96%, 97%, 98%, 99%, 99.5%, 99.9% or 99.99% by mass on the basis of silica or alumina and silica;
Purity of less than 80%, 82%, 84%, 86%, 88%, 90%, 92%, 94%, 95%, 96%, 97%, 98%, 99%, 99.5%, 99.9% or 99.99% by mass on the basis of silica or alumina and silica;
Amorphous content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 82%, 84%, 86%, 88%, 90%, 92%, 94%, 95%, 96%, 97%, 98%, 99%, 99.5%, 99.9% or 99.99%, by mass or volume;
Amorphous content of less than 0.01%, 0.05%, 0.1%, 0.2%, 0.4%, 0.6%, 0.8%, 1%, 1.5%, 2%, 3%, 4%, 5%, 6%, 7%, 8%, 9%, 1%, 2%, 14%, 16%, 18%, 20%, 25%, 30%, 35%, 40%, 45%, 50%, 55%, 60%, 65%, 70%, 75%, 80%, 82%, 84%, 86%, 88%, 90%, 92%, 94%, 95%, 96%, 97%, 98%, 99%, 99.5%, 99.9% or 99.99%, by mass or volume;
Silica or SiO₂ content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Silica or SiO₂ content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 2%, 14%, %, 16%, 18%, 20%, 25%, 30%, 35%, 40%, 45%, 50%, 55%, 60%, 65%, 70%, 75%, 80%, 85%, 90%, 95%, 98%, or 99% by mass;
Alumina or Al₂O₃ content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Alumina or Al₂O₃ content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Iron oxide or Fe₂O₃ content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Iron oxide or Fe₂O₃ content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sodium oxide or Na₂O content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sodium oxide or Na₂O content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Potassium oxide or K₂O content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Potassium oxide or K₂O content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sum of Sodium and potassium oxide or Na₂O+K₂O content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sum of Sodium and potassium oxide or Na₂O+K₂O content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sum of calcium oxide, magnesium oxide, and iron oxide or CaO+MgO+Fe₂O₃ content of at least 4%, 6%, 8%, 10%, 12%, 14%, 16%, 18%, or 20%;
Sum of calcium oxide, magnesium oxide, and iron oxide or CaO+MgO+Fe₂O₃ content of at most 4%, 6%, 8%, 10%, 12%, 14%, 16%, 18%, or 20%;
Calcium carbonate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Calcium carbonate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Magnesium oxide content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Magnesium oxide content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Magnesium hydroxide content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Magnesium hydroxide content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Calcium oxide content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Calcium oxide content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Chloride content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18, 20%, 25%, 30%, 35%, 40%, 45%, 50%, 55%, 60%, 65%, 70%, 75%, 80%, 85%, 90%, 95%, 98%, or 99% by mass;
Chloride content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Nitrate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Nitrate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Nitrite content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Nitrite content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sulfate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sulfate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sulfite content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Sulfite content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, 98%, or 99% by mass;
Phosphate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 2%, 14%, 16%, 18%, 20%, 25%, 30%, 35%0, 40%, 45%, 50%, 55%, 60%, 65%, 70%, 75%, 80%, 85%, 90%, 95%, 98%, or 99% by mass; and/or
Phosphate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%0, 40%, 45%, 50%, 55%, 60%, 65%, 70%, 75%, 80%, 85%, 90%, 95%, 98%, or 99% by mass.

In some embodiments, the water demand of a pozzolan paste of the first and/or second insoluble product can be less than 0.2, 0.25, 0.3, 0.35, 0.4, 0.45, 0.5, 0.55, 0.6, 0.65, 0.7, 0.75, 0.8, 0.85, 0.9 on a weight basis to obtain a sufficiently flowable colloidal suspension. The water demand is determined from the rheology of a colloidal suspension of pozzolan and water compared to a reference solution. According to one method, the reference solution is ordinary portland cement as defined by ASTM C150: Specification for Portland Cement, and water as defined by ASTM C1682: Specification for Mixing Water Used in the Production of Hydraulic Cement Concrete, in a mass ratio of 0.4:1 parts water to cement. For example, the amounts used may be 100 g of ordinary portland cement and 40 g of water. The reference suspension is used for calibration, preferably by one skilled in the art of cement testing. The test colloidal suspension may be prepared by adding 100 g of dry pozzolan to a mixing container, and adding 10 g of water. This mixture may be mixed well by hand for at least a minute, at which point the viscosity of the colloidal suspension is compared to the reference described above. If the viscosity is deemed higher than the reference solution, water may be added in 5 g increments and mixed again for one minute. This process may be repeated until the sample solution has the same viscosity as the reference solution prepared. The final water demand is determined by dividing the total amount of water added to the colloidal suspension by the starting amount of dry pozzolan used.

In some embodiments, flow table spread of a pozzolan mortar of the first and/or second insoluble product can be at least 20%, 30%, 40%, 50%, 60%, 70%, 80%, 90%, 100%, 105%, 110%, 115%, 120%, 130%, 140%, or 150% as measured using the method and apparatus described in ASTM C1437: Standard Test Method for Flow of Hydraulic Cement Mortar, using a mortar with a ratio of 1:2.75 pozzolan to Graded Test sand as defined by ASTM C109. The mortar may be prepared using a water to dry pozzolan ratio of 0.485:1 following the ratio outlined in ASTM C109, where said water is defined by ASTM C1682: Specification for Mixing Water Used in the Production of Hydraulic Cement Concrete. The mortar may be mixed in accordance with the mixing procedure included in ASTM C109: Test Method for Compressive Strength of Hydraulic Cement Mortars (using 2-in. Or [50-mm] Cube Specimens).

In some embodiments, the water demand of a pozzolan mortar of the first and/or second insoluble product can be less than 0.2, 0.25, 0.3, 0.35, 0.4, 0.45, 0.5, 0.55, 0.6, 0.65, 0.7, 0.75, 0.8, 0.85, 0.9 on a weight basis while obtaining a flowable colloidal suspension. The water demand of a pozzolan mortar may be determined by preparing a mortar mix that includes dry pozzolan and Graded Test Sand as defined by ASTM C109: Test Method for Compressive Strength of Hydraulic Cement Mortars (using 2-in. Or [50-mm] Cube Specimens), in a 1:2.75 mass ratio. This mass ratio may be determined by ASTM C109, a standard ratio of cementitious material to sand. The actual amount of dry pozzolan used may be 250 g and the actual amount of sand used may be 687.5 g. Water as defined by ASTM C1682: Specification for Mixing Water Used in the Production of Hydraulic Cement Concrete, may be added initially at a weight fraction of 0.1, or 25 g, and the mixing procedure specified in ASTM C109 may be used to prepare the mortar. The mortar may be evaluated for flow using the method and apparatus found in ASTM C1437: Standard Test Method for Flow of Hydraulic Cement Mortar. If the mortar flow is less than 30%, a weight fraction of 0.05, or 12.5 g, may be added to the mortar. The mixing procedure specified in ASTM C109 may be conducted again, following which the flow determination procedure found in ASTM C1437 may be conducted. This process may be repeated until the sample suspension has a mortar flow greater than 30%. The final water demand is determined by dividing the total amount of water added to the colloidal suspension by the starting amount of dry pozzolan used. The sand is not included in the weight determination.

In some embodiments, some of these properties of the first and/or second insoluble product (e.g., pozzolan) may improve its performance in cement. In some embodiments, pozzolans with a large primary particle diameter, small specific surface area, and/or small micropore volume may correlate with low water demand. That is to say, these properties may mean less water must be added to cement containing such pozzolan or pozzolans in order to achieve sufficiently high flow, large slump, or low viscosity. This may be because particles with large primary particle diameter, small specific surface area, and/or small micropore volume adsorb or absorb smaller amounts of water, have smaller surface friction, have smaller viscous forces in suspension, or for other related reasons. Cements and/or concretes with lower water demand may perform better because they can have sufficient flow, slump, or viscosity to be cast, pumped, or poured as needed to meet the requirements of a particular application, while having less water added to the blend. Adding less water to the blend may result in higher compressive strength and/or shorter setting times. This may be because adding less water leads to lower pore volume in the hydrated, set, and/or hardened cement, mortar, or concrete, and reduced pore volume is correlated with increased compressive strength. In some embodiments, particles with certain diameters or diameter distributions may enable higher packing efficiency or filling in of gaps or voids between particles or aggregates in cement or concrete, resulting in a denser material with higher compressive strength. Cements, mortars, or concretes made with lower water to binder ratios may also have lower permeability due to lower porosity and a less interconnected pore structure (more closed and isolated pores), and therefore may resist penetration by chlorides, sulfates, or other ionic or molecular species that could lead to degradation of building materials or structures.

In some embodiments, the first and/or second insoluble product (i.e., the siliceous material, supplementary cementitious material (SCM), or pozzolan) has a requirement of no more than about 15% more water than the OPC control to achieve flow within about 5% of the OPC control when tested for Strength Activity Index (SAI) in accordance with ASTM C618. In some embodiments, the first and/or second insoluble product has a SAI of greater than about 80% at 7-days when tested for SAI in accordance with ASTM C618. In some embodiments, the first and/or second insoluble product has a SAI of greater than about 85% at 28-days when tested for SAI in accordance with ASTM C618. In some embodiments, the first and/or second insoluble product has a heat release of less than about 350 J/g as measured by Method A of ASTM C1897-20. In some embodiments, the first and/or second insoluble product has a water-soluble or acid-soluble chloride content of less than about 2% as measured by ASTM C1218. In some embodiments, the first and/or second insoluble product has an amorphous content of less than about 50%. In some embodiments, the first and/or second insoluble product has an apparent packed density of less than 1.5 grams per mL as measured by the method in ASTM C110 or a similar method. In some embodiments, the first and/or second insoluble product is capable of reacting with portlandite to convert a portion of its crystalline silicates to amorphous CSH gel in cementitious mixes comprising portland cement or portlandite.

In some embodiments, the first and/or second insoluble product (i.e., the siliceous material, supplementary cementitious material (SCM), or pozzolan) is a leached pozzolan. The leached pozzolan reactivity can be measured in multiple ways including the strength activity index test as described in ASTM C311-18, “Standard Test Methods for Sampling and Testing Fly Ash or Natural Pozzolans for Use in Portland-Cement Concrete,” pozzolan reactivity test (PRT) or R3 tests as described in ASTM C1897-20: Standard Test Methods for Measuring the Reactivity of Supplementary Cementitious Materials by Isothermal Calorimetry and Bound Water Measurements, the Lime-Pozzolan Strength Development mortar test as described in ASTM C593-19, “Specification for Fly Ash and Other Pozzolans for Use With Lime for Soil Stabilization,” or others. Increased reactivity can be correlated to various parameters including increased amorphous content measured by XRD, increased surface area measured by BET, increased mortar strength, increased heat release by isothermal calorimetry, and/or increased bound water per ASTM C1897-20. In some embodiments, at least 10% of the silicate is converted to an amorphous phase during a 7-day PRT or R3 test at 50° C. or 40° C., respectively. In some embodiments, at least 20% of the silicate is converted or over 30% of the silicate is converted into an amorphous phase. In some embodiments, at least 40 grams of portlandite per 100 grams of silicate are consumed during the 7-day PRT test at 50° C. In some embodiments, over 60 grams of portlandite per 100 grams of silicate or over 75 grams of portlandite per 100 grams of silicate.

One of the most widely deployed pozzolans is fly ash derived from combustion furnaces. Fly ash has high amorphous content but still relatively low reactivity during the first week of cement or concrete curing. As a result, the total amount of fly ash that can be added to a mix is around 20% before significant performance deterioration is observed in short-term strength and set times increase significantly. While results vary depending on the fly ash, a fly ash added at 20% may reduce the 7-day compressive strength of an OPC mortar by 10-20% despite increasing compressive strength at longer times (such as 90 days).

Pozzolans capable maintaining mortar strength at 7 days to within 20% of an OPC control when blended at greater than or equal to 20%, can be desirable as they would allow greater displacement of energy and carbon intensive OPC with less intensive pozzolans. In some embodiments, the leached pozzolan or leached pozzolan blend can maintain compressive strength at 7 days within about 20%, within about 15%, within about 10%, within about 5%, match the OPC control, or exceed the OPC control by at least 5%, 10%, 15%, 20%, 25%, 30%, 35%, 40%, 45%, or 50%. In some embodiments, the leached pozzolan or leached pozzolan blend can maintain compressive strength at 7 days within about 20% or maintain compressive strength within about 5%.

Similarly, an effective pozzolan can also be expected to maintain the mortar strength to within about 20% of the OPC control at 28 days. In some embodiments, the leached pozzolan (i.e., first and/or second insoluble product herein) or leached pozzolan blend can maintain compressive strength at 28 days within about 20%, within about 15%, within about 10%, or within about 5% of the OPC control, meets the compressive strength at 28 days of the OPC control, and/or exceeds the compressive strength at 28 days of the OPC control. In some embodiments, the leached pozzolan or leached pozzolan blend can maintain compressive strength at 28 days within about 10% and/or meets or exceeds the compressive strength of the OPC control. In some embodiments, the mortar can exceed the compressive strength of the OPC control at 28 days by 10%, 25%, 50%, or even up to 60%.

In the C618 requirements, the ASTM requires the appropriate quantity of water to be added to maintain the same flow as the OPC control. The water required should not exceed more than about 15% of the water required for the OPC. Therefore, it can be desirable for pozzolans to achieve equivalent flow to OPC with less than about 15% additional water. In some embodiments, the leached pozzolans disclosed herein achieve equivalent flow to OPC with less than about 15%, less than about 10%, or less than about 5% additional water. In some embodiments, the pozzolans can achieve within 5% of the flow of OPC with the same amount of water used.

In some embodiments, the first and/or second insoluble product has a heat of reaction with lime measured at 7 days of between about 75 J/g and about 200 J/g. In some embodiments, the first and/or second insoluble product has a heat of reaction with lime measured at 7 days of at least about 75 J/g, at least about 80 J/g, at least about 90 J/g, at least about 100 J/g, at least about 110 J/g, at least about 120 J/g, at least about 130 J/g, at least about 140 J/g, at least about 150 J/g, at least about 160 J/g, at least about 170 J/g, at least about 180 J/g, or at least about 190 J/g. In some embodiments, the first and/or second insoluble product has a heat of reaction with lime measured at 7 days of less than about 200 J/g, less than about 190 J/g, less than about 180 J/g, less than about 170 J/g, less than about 160 J/g, less than about 150 J/g, less than about 140 J/g, less than about 130 J/g, less than about 120 J/g, less than about 110 J/g, less than about 100 J/g, less than about 90 J/g, or less than about 80 J/g. In some embodiments, the first and/or second insoluble product has a heat of reaction with lime measured at 10 days of between about 75 J/g and about 200 J/g. In some embodiments, the first and/or second insoluble product has a heat of reaction with lime measured at 7 days of at least about 75 J/g, at least about 80 J/g, at least about 90 J/g, at least about 100 J/g, at least about 110 J/g, at least about 120 J/g, at least about 130 J/g, at least about 140 J/g, at least about 150 J/g, at least about 160 J/g, at least about 170 J/g, at least about 180 J/g, or at least about 190 J/g. In some embodiments, the first and/or second insoluble product has a heat of reaction with lime measured at 10 days of less than about 200 J/g, less than about 190 J/g, less than about 180 J/g, less than about 170 J/g, less than about 160 J/g, less than about 150 J/g, less than about 140 J/g, less than about 130 J/g, less than about 120 J/g, less than about 110 J/g, less than about 100 J/g, less than about 90 J/g, or less than about 80 J/g. Isothermal calorimetry heats measured at 7 or 10 days between about 75 J/g and about 150 J/g can be preferred but more reactive materials can range between up to about 200 J/g or exceed about 200 J/g.

The reactivity of a pozzolan can also be inferred through the increase in strength from 7 days to 28 days when tested in the Strength Activity Index test as described in ASTM C311 and referenced in ASTM C618. In this test, dry leached silicate would be used in a blend of about 20% silicate and about 80% OPC and tested for compressive strength. Whereas an OPC control would only be expected to gain around 5 MPa in compressive strength from 7 to 28 days, highly reactive silicates may increase the compressive strength from 7 to 28 days by about 10 MPa or more. In some embodiments, the first and/or second insoluble product can gain at least about 5 MPa, at least about 6 MPa, at least about 7 MPa, at least about 8 MPa, at least about 9 MPa, or at least about 10 MPa in compressive strength from 7 to 28 days.

Feedstocks where the leaching of acid soluble cations causes a reduction in mass of greater than about 35% on a dry weight basis may produce highly reactive silicates. In some embodiments, the reactivity of these silicates can be quantified through isothermal calorimetry using PRT method where a mixture of lime, the pozzolan, water, and potassium hydroxide can be mixed and tested in an isothermal calorimeter at 50° C. Highly reactive leached materials can release heats of >150 J/g and preferable >200 J/g. In some embodiments, the first and/or second insoluble product can release a heat of at least about 150 J/g, at least about 160 J/g, at least about 170 J/g, at least about 180 J/g, at least about 190 J/g, or at least about 200 J/g according to the PRT method discussed above.

Highly reactive silicates may be blended with less reactive silicates having either a lesser reactivity in isothermal calorimetry, lower increase in compressive strength gain from 7 to 28 days, or both. This may be achieved by mixing or blending feedstocks with different properties before acid digestion (i.e., leaching), during the acid digestion simultaneously or sequentially, or by mixing different pozzolans resulting from separate leaching steps after the digestion is complete, or a combination of these approaches. The blended material would preferably have a good mix of flow, 7-day, and 28-day strength. In some embodiments, the reactivity of the first and/or second insoluble product and the second material is measured by at least one of: SAI as measured in ASTM C618; or heat release as measured by Method A of ASTM C1897-20.

In some embodiments, the first process stream or leachate can be reacted in a second reaction chamber with a base. In some embodiments, the first process stream or leachate can be reacted in a second reaction chamber with a base generated by the electrolyzer to form a first solid product (e.g., a first metal (e.g., iron)). For example, the first process stream or leachate 02 can be reacted in a second reaction chamber 102 with the base (e.g., NaOH) 11 generated by the electrolyzer 100 to form a first solid product 03 and a second process stream or leachate 04. In some embodiments, the first solid product can include iron oxides and/or iron hydroxides as well as oxides and/or hydroxides of other metals in the feed material. In some embodiments, the first solid product can include iron oxyhydroxides as well as oxyhydroxides of other metals. In some embodiments, the second leachate or second process stream can be a liquid fraction or leachate that includes ions of a second metal different from the metal formed in the first solid product. In some embodiments, the second leachate or second process stream can include an alkaline earth metal (e.g., calcium and/or magnesium) compound (e.g., salt and/or cation). For example, the second process stream or leachate 04 may be a liquid fraction or leachate including alkaline earth metal compounds such as magnesium acetate ((CH₃COO)₂Mg) and calcium acetate ((CH₃COO)₂Ca) that can be generated by reactions between the weak acid (e.g., acetic acid) and the alkaline earth metal containing components (e.g., magnesium and/or calcium containing components) of the feed material 14.

In some embodiments, the second process stream or leachate can be reacted in a third reaction chamber with a base. In some embodiments, the second process stream or leachate can be reacted in a third reaction chamber with a base generated by the electrolyzer to form a second solid product (e.g., a second metal (e.g., magnesium)). For example, the second process stream or leachate 04 can be reacted in a third reaction chamber 103 with the base (e.g., NaOH) 12 generated by the electrolyzer 100 to form a second solid product 05 and a third process stream or leachate 06. In some embodiments, the second solid product can include magnesium oxides and/or hydroxides as well as oxides and/or hydroxides of other metals in the feed material. In some embodiments, the second solid product can include magnesium hydroxide. In some embodiments, the third leachate or third process stream can be a liquid fraction or leachate that includes ions of a third metal (e.g., calcium) different from the metal formed in the first and second solid product. In some embodiments, the third leachate or third process stream can include an alkaline earth metal (e.g., calcium) compound (e.g., salt and/or cation). For example, the third process stream or leachate 06 may be a liquid fraction or leachate including alkaline earth metal compounds such as calcium acetate that can be generated by reactions between the weak acid (e.g., acetic acid) and the alkaline earth metal containing components (e.g., calcium containing components) of the feed material 14. In some embodiments, the third leachate or process stream 06 may have a pH of greater than 9, such as a pH ranging from about 10 to about 12. In some embodiments, the third reaction chamber can produce a second product stream 05. In some embodiments, the second product stream can include a magnesium product. In some embodiments, the second product stream 05 can be a solids fraction including a precipitated product generated by the reaction of the second leachate or process stream with the base from the electrolyzer. In some embodiments, the second solids product may be a magnesium product that can be a solids fraction including precipitated magnesium hydroxide Mg(OH)₂ generated by reacting magnesium acetate and the base. In some embodiments, the second solid product may be collected and stored in a suitable container.

In some embodiments, the magnesium hydroxide can have purity of over 90% or over 95%. This can be accomplished by including the upstream precipitation operated in such a way to remove residual manganese, iron, and/or aluminum from the solution prior to precipitation of the magnesium hydroxide. In some embodiments, this can be performed at a pH between 5 and 7 such that most of the iron and aluminum can be removed but the magnesium remains in solution. This upstream precipitation step can be accomplished as part of a leaching step if the acid is allowed to neutralize to the point where the pH reaches the 5-7 range. In some embodiments, the precipitation of the magnesium hydroxide can be performed at a pH between 6 and 9, where the magnesium precipitates but not the calcium.

To ensure effective removal of manganese from magnesium, methods other than pH may be required to reach the target magnesium purity. For example, using carbonates, such as sodium carbonate, potassium carbonate, calcium carbonate, magnesium carbonate, or ammonium carbonate, can increase the removal of manganese compared to using non-carbonated bases for precipitation. The use of carbonate bases can be effective at selectively precipitating metals other than magnesium because the carbonate of magnesium is significantly more soluble than the carbonates of calcium, manganese, and ferrous iron.

Use of oxidation reactions can also improve the separation of magnesium and manganese. For example, iron and/or manganese present in the relatively soluble divalent state (Fe²⁺ or Mn²⁺) can be oxidized through the addition of an oxidant (such as oxygen, bleach, chlorine, sulfur dioxide, potassium permanganate, or peroxides) and/or the release of a reductant (such as hydrogen) to their higher, and less soluble, oxidation states to form precipitates including Fe₂O₃, Fe₃O₄, Mn₂O₃, Mn₃O₄, or MnO₂. In some embodiments, this may involve bubbling in oxygen or air for greater than 2 hours, greater than 6 hours, greater than 12 hours, or greater than 24 hours.

In some embodiments, the third process stream or leachate can be reacted in a fourth reaction chamber with a base. In some embodiments, the third process stream or leachate can be reacted in a fourth reaction chamber with a base generated by the electrolyzer to form a third solid product (e.g., a third metal (e.g., calcium)). For example, the third process stream or leachate 06 can be reacted in a fourth reaction chamber 104 with the base (e.g., NaOH) 13 generated by the electrolyzer 100 to form a third solid product 07 and a fourth process stream or leachate 08 (e.g., a brine stream). In some embodiments, the third solid product can include calcium oxides and/or hydroxides as well as oxides and/or hydroxides of other metals in the feed material. In some embodiments, the third solid product can include calcium hydroxide. In some embodiments, the fourth leachate or fourth process stream can be a liquid fraction or leachate that includes a salt (e.g., sodium) of the anion from the weak acid (e.g., acetate). In some embodiments, the fourth reaction chamber can produce a third product stream 07. In some embodiments, the third product stream can include a calcium product. In some embodiments, the third product stream 07 can be a solids fraction including a precipitated product generated by the reaction of the third leachate or process stream with the base from the electrolyzer. In some embodiments, the third solids product may be a calcium product that can be a solids fraction including precipitated calcium hydroxide Ca(OH)₂ generated by reacting calcium acetate and the base. The product 07 may be collected and stored in a suitable container. In some embodiments, the fourth leachate or process stream 08 (e.g., brine or salt stream) may be recycled to the electrolyzer 100. In some embodiments, the fourth leachate or process stream can be sent to the electrolyzer in order to regenerate the weak acid and/or base. The brine process stream 08 may have a pH of greater than 10, such as a pH ranging from about 11 to about 14.

In some embodiments, the reactors 103 and 104 shown in FIGS. 1-3 can be combined and produce a mixed magnesium and calcium product. For example, FIG. 6 illustrates process stream or leachate from a reaction chamber (e.g., Leach 1) that can be reacted in a reaction chamber with a base to form a mixed product. In some embodiments, this process stream or leachate can be reacted in a reaction chamber with a base generated by the electrolyzer to form a solid product. For example, this process stream or leachate can be reacted in a reaction chamber (e.g., Alkaline earth metal precipitation) with the base (e.g., NaOH) generated by the electrolyzer to form a solid product and another process stream or leachate (e.g., a brine stream). In some embodiments, this solid product can include calcium oxides and/or hydroxides, magnesium oxides and/or hydroxides, and/or oxides and/or hydroxides of other metals in the feed material. In some embodiments, the solid product can include calcium hydroxide and/or magnesium hydroxide. In some embodiments, the leachate or process stream from the alkaline earth metal precipitation reaction chamber can be a liquid fraction or leachate that includes a salt (e.g., sodium) of the anion from the weak acid (e.g., acetate). In some embodiments, this reaction chamber can produce a product stream. In some embodiments, the product stream can include a calcium and/or magnesium product. In some embodiments, this product stream can be a solids fraction including a precipitated product generated by the reaction of the leachate or process stream from the Leach 1 reaction chamber with the base from the electrolyzer. In some embodiments, this solids product may be a calcium product and/or magnesium product that can be a solids fraction including precipitated calcium hydroxide Ca(OH)₂ and/or precipitated magnesium hydroxide generated by reacting calcium acetate and/or magnesium acetate with the base. The product may be collected and stored in a suitable container. In some embodiments, the leachate or process stream (e.g., brine or salt stream) from the precipitation reaction chamber may be recycled to the electrolyzer. In some embodiments, the leachate or process stream can be sent to the electrolyzer in order to regenerate the weak acid and/or base.

In some embodiments, the calcium hydroxide (lime) stream can have a purity greater than 80%, 90%, over 95%, or over 98% once filtered, washed, and/or dried. This can be accomplished by operating the upstream magnesium precipitation to remove more than 80% or more than 90% of the magnesium from the solution. To extract the most value from the lime product and reduce the burden on any downstream brine treatment systems, it can be preferable to precipitate more than 90% of the calcium as lime or to precipitate more than 98% of the calcium as lime.

Hydroxides precipitated may possess morphologies depending on the weak acid chosen. In some embodiments, a calcium hydroxide with a platelet morphology can be produced through precipitation from organic anions. In some embodiments, that organic anion may be lactate, formate, citrate, acetate, maleate, gluconate, or tartrate. In some embodiments, the tap density of the material is advantageously high, which can promote materials that filter better and flow better when used in cement or concrete.

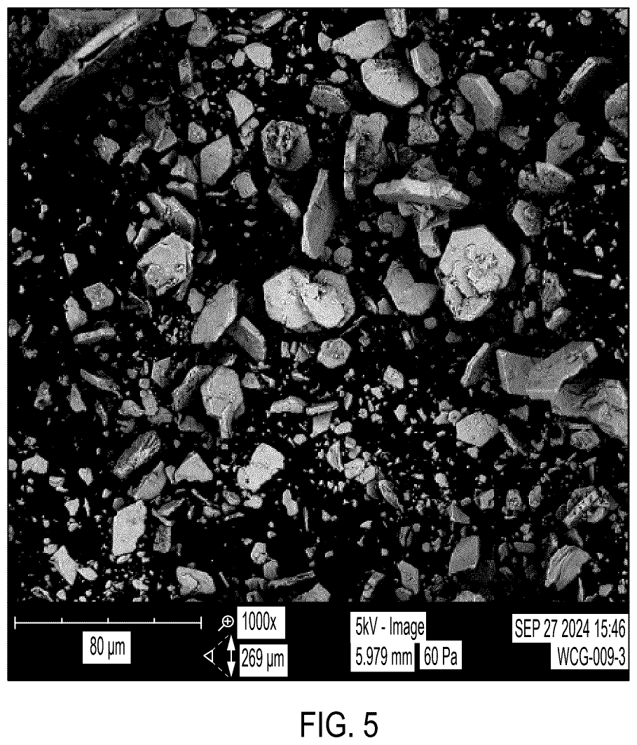

FIG. 5 is a scanning electron micrograph of calcium hydroxide produced through precipitation of calcium from an acetate solution using sodium hydroxide as would be generated through the embodiments disclosed herein with acetic acid for a range of calcium bearing industrial byproduct and waste feedstocks. In some embodiments, the calcium hydroxide has a platelet morphology with an aspect ratio of greater than two, wherein the aspect ratio is calculated by the hydraulic diameter (four times the area of the platelet surface divided by the perimeter of the surface) or length of the platelet plane divided by the platelet thickness as can be measured in scanning electron micrographs. As can be seen in FIG. 5, the use of the weak acid (e.g., acetic acid) leads to the formation of platelet style crystals with aspect ratios greater than 2. These platelets can have several advantages versus prismatic shaped crystals that would form from strong acids such as chloride or nitrate. Specifically, platelets may have greater settling velocities due to the reduced drag coefficient and may filter at faster rates because of how they stack. Both faster settling velocities and faster filtering rates can make separating and washing platelets easier than prismatic crystals formed by precipitating calcium from strong acids.

Once dried, the platelets of calcium hydroxide produced from the precipitation of calcium from weak acid systems may also have a tap density that is greater than 0.8 g/mL, greater than 0.9 g/mL, and greater than 1 g/mL as measured by ASTM standards such as the measurement in ASTM C110 for apparent packed density of hydrated lime. In some embodiments, the platelets of calcium hydroxide produced from the precipitation of calcium from weak acid systems may also have a tap density that is less than 2.5 g/mL or less than 2 g/mL as measured by ASTM standards such as the measurement in ASTM C110 for apparent packed density of hydrated lime. This can be significantly higher than the tap density of calcium hydroxide produced in kilns that were measured at 0.48 g/mL. The higher tap density of the lime produced from the processes disclosed herein can have better packing and better flow when used as a part of a cement mortar or concrete.

In some embodiments, calcium compound/solid (e.g., calcium oxide or hydroxide) and/or magnesium compound/solid (e.g., magnesium oxide or hydroxide) produced herein may be used as an additive or component to cement, concrete, and/or related construction and building materials. This ingredient or component may comprise lime (calcium oxide or hydroxide), quicklime (calcium oxide, CaO), hydrated lime (calcium hydroxide, Ca(OH)₂), magnesia (magnesium oxide, MgO), milk of magnesium (magnesium hydroxide, Mg(OH)₂), or a mixture thereof. In some embodiments, the lime and/or magnesium compound as described herein may be hydrated lime. The lime and/or magnesium compound may contain impurities of elements other than calcium, magnesium, oxygen, and hydrogen. In some embodiments, it might contain as much as 50% by mass magnesium oxide or magnesium hydroxide. In some embodiments, this component may be a mixed metal calcium/magnesium hydroxide, wherein the solid particles contain both calcium and magnesium. In some embodiments, this component may be a dry powder mixture containing a fraction of relatively pure (>60%, 70%, 80%, 90%, 95%, or 98% by mass) Ca(OH)₂ particles and another fraction of relatively pure (>60%, 70%, 80%, 90%, 95%, or 98% by mass) Mg(OH)₂ particles. The lime and/or magnesium compound may also contain other trace impurities, such as compounds of aluminum, silicon, iron, sodium, potassium, chlorine, nitrogen, sulfur, and/or other elements. These impurities may include chloride ions, sulfate ions, and/or nitrate ions. The lime and/or magnesium compound may be in the form of solid particles with major diameters between 1 nm and 1 mm. In some embodiments, the lime and/or magnesium compound particle major diameter range may be 500 nm-30 microns. The lime and/or magnesium compound may be a dry, free flowing powder. The lime may also contain some moisture as adsorbed, absorbed, and/or liquid water. The lime and/or magnesium compound may be a suspension of particles in water or an aqueous solution such as a sodium hydroxide solution. In some embodiments, the low-embodied-carbon cement blend can contain at least 1% by mass of the lime or magnesium compound. In some embodiments, the cement blend can contain 5-50% by mass of hydrated lime.

In some embodiments, the lime (e.g., calcium oxide and/or calcium hydroxide) and/or magnesium compound may have one or more of the following attributes, including combinations and variations of the following:

Specific surface area of at least 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, or 1000 m²/g as measured using a Brunauer-Emmett-Teller (BET) technique;
Specific surface area of less than 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, or 1000 m²/g as measured using a Brunauer-Emmett-Teller (BET) technique;
A micropore volume and/or a Barrett, Joyner and Halenda (BJH) pore volume of at least 0.01 mL/g, 0.02 mL/g, 0.03 mL/g, 0.04 mL/g, 0.05 mL/g, 0.06 mL/g, 0.07 mL/g, 0.08 mL/g, 0.09 mL/g, 0.10 mL/g, 0.11 mL/g, 0.12 mL/g, 0.13 mL/g, 0.14 mL/g, 0.15 mL/g, 0.16 mL/g, 0.17 mL/g, 0.18 mL/g, 0.19 mL/g, 0.20 mL/g, 0.25 mL/g, 0.30 mL/g, 0.40 mL/g, 0.50 mL/g, 0.60 mL/g, 0.70 mL/g, 0.80 mL/g, 0.90 mL/g, 1.00 mL/g, 1.2 mL/g, 1.4 mL/g, 1.6 mL/g, 1.8 mL/g, 2 mL/g, 3 mL/g, 4 mL/g, 5 mL/g, 6 mL/g, 7 mL/g, 8 mL/g, 9 mL/g, 10 mL/g, 20 mL/g, 30 mL/g, 40 mL/g, or 50 mL/g as measured using a Brunauer-Emmett-Teller (BET) technique;
A micropore volume and/or a Barrett, Joyner and Halenda (BJH) pore volume of less than 0.01 mL/g, 0.02 mL/g, 0.03 mL/g, 0.04 mL/g, 0.05 mL/g, 0.06 mL/g, 0.07 mL/g, 0.08 mL/g, 0.09 mL/g, 0.10 mL/g, 0.11 mL/g, 0.12 mL/g, 0.13 mL/g, 0.14 mL/g, 0.15 mL/g, 0.16 mL/g, 0.17 mL/g, 0.18 mL/g, 0.19 mL/g, 0.20 mL/g, 0.25 mL/g, 0.30 mL/g, 0.40 mL/g, 0.50 mL/g, 0.60 mL/g, 0.70 mL/g, 0.80 mL/g, 0.90 mL/g, 1.00 mL/g, 1.2 mL/g, 1.4 mL/g, 1.6 mL/g, 1.8 mL/g, 2 mL/g, 3 mL/g, 4 mL/g, 5 mL/g, 6 mL/g, 7 mL/g, 8 mL/g, 9 mL/g, 10 mL/g, 20 mL/g, 30 mL/g, 40 mL/g, or 50 mL/g as measured using a Brunauer-Emmett-Teller (BET) technique;
Blaine fineness (air-permeability specific surface area) of at least 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, or 1000 m²/g as measured using the method and apparatus described in ASTM C204: Test Methods for Fineness of Hydraulic Cement by Air-Permeability Apparatus;
Blaine fineness (air-permeability specific surface area) of less than 0.01 m²/g, 0.05 m²/g, 0.1 m²/g, 0.3 m²/g, 0.5 m²/g, 0.7 m²/g, 1 m²/g, 2 m²/g, 3 m²/g, 4 m²/g, 5 m²/g, 6 m²/g, 7 m²/g, 8 m²/g, 9 m²/g, 10 m²/g, 12 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 90 m²/g, 100 m²/g, 120 m²/g, 150 m²/g, 200 m²/g, 300 m²/g, 400 m²/g, 500 m²/g, 700 m²/g, or 1000 m²/g as measured using the method and apparatus described in ASTM C204: Test Methods for Fineness of Hydraulic Cement by Air-Permeability Apparatus;
Hexagonal prism and/or hexagonal antiprism morphology;
Average roughness factor of less than 1.1, 1.2, 1.3, 1.5, 1.75, 2, 2.5, 3, 4, 5, 6, 7, 8, 9, 10, 15, 20, 25, 30, 40, 50, 60, 70, 80, 90, or 100, where roughness factor is defined as the quotient of a particle's actual surface area to volume ratio to the surface area to volume ratio expected for a sphere having the same volume as the actual particle;
Average primary particle diameter of at least 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Average primary particle diameter of less than 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Narrow particle size distribution, as defined by having at least 50%, 60%, 70%, 80%, 90%, 95%, or 99% of particles by count or by mass within a diameter range having a width of less than 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Wide particle size distribution, as defined by having at least 50%, 60%, 70%, 80%, 90%, 95%, or 99% of particles by count or by mass within a diameter range having a width of at least 1 nm, 2 nm, 3 nm 5 nm, 10 nm, 30 nm, 50 nm, 70 nm, 100 nm, 200 nm, 300 nm, 500 nm, 700 nm, 1 micron, 2 micron, 3 micron, 4 micron, 5 micron, 6 micron, 7 micron, 8 micron, 9 micron, 10 micron, 12 micron, 15 micron, 20 micron, 25 micron, 30 micron, 35 micron, 40 micron, 50 micron, 60 micron, 70 micron, 80 micron, 90 micron, 100 micron, 120 micron, 150 micron, 200 micron, 250 micron, 300 micron, 400 micron, 500 micron, 600 micron, 700 micron, 800 micron, 900 micron, or 1 mm;
Amorphous content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 82%, 84%, 86%, 88%, 90%, 92%, 94%, 95%, 96%, 97%, 98%, 99%, 99.5%, 99.9% or 99.99%, by mass or volume;
Amorphous content of less than 0.01%, 0.05%, 0.1%, 0.2%, 0.4%, 0.6%, 0.8%, 1%, 1.5%, 2%, 3%, 4%, 5%, 6%, 7%, 8%, 9%, 1, 12%, 14%, 16%, 18%, 20%, 25%, 30%, 35%, 40%, 45%, 50%, 55%, 60%, 65%, 70%, 75%, 80%, 82%, 84%, 86%, 88%, 90%, 92%, 94%, 95%, 96%, 97%, 98%, 99%, 99.5%, 99.9% or 99.99%, by mass or volume;
Specific surface area to major diameter ratio of at least 0.1 (m²/g)/micron, 0.2 (m²/g)/micron, 0.3 (m²/g)/micron, 0.5 (m²/g)/micron, 0.7 (m²/g)/micron, 1 (m²/g)/micron, 3 (m²/g)/micron, 5 (m²/g)/micron, 7 (m²/g)/micron, 10 (m²/g)/micron, 20 (m²/g)/micron, 30 (m²/g)/micron, 40 (m²/g)/micron, 50 (m²/g)/micron, 70 (m²/g)/micron, or 100 (m²/g)/micron;
Specific surface area to major diameter ratio of less than 0.1 (m²/g)/micron, 0.2 (m²/g)/micron, 0.3 (m²/g)/micron, 0.5 (m²/g)/micron, 0.7 (m²/g)/micron, 1 (m²/g)/micron, 3 (m²/g)/micron, 5 (m²/g)/micron, 7 (m²/g)/micron, 10 (m²/g)/micron, 20 (m²/g)/micron, 30 (m²/g)/micron, 40 (m²/g)/micron, 50 (m²/g)/micron, 70 (m²/g)/micron, or 100 (m²/g)/micron;
Purity of at least 80%, 82%, 84%, 86%, 88%, 90%, 92%, 94%, 95%, 96%, 97%, 98%, 99%, 99.5%, 99.9% or 99.99% by mass calcium oxide or calcium hydroxide;
Purity of less than 80%, 82%, 84%, 86%, 88%, 90%, 92%, 94%, 95%, 96%, 97%, 98%, 99%, 99.5%, 99.9% or 99.99% by mass calcium oxide or calcium hydroxide;
Silica content of at least 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Silica content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Calcium carbonate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Calcium carbonate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Magnesium oxide content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Magnesium oxide content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Magnesium hydroxide content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Magnesium hydroxide content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Calcium oxide content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 2%, 14%, 16%, 18%, 20%, 25%, 30%, 35%, 40%, 45%, or 50% by mass;
Calcium oxide content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Chloride content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Chloride content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1%, 2%, 14%, 16%, 18%, 20%, 25%, 30%, 35%, 40%, 45%, or 50% by mass;
Nitrate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Nitrate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Nitrite content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Nitrite content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Sulfate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Sulfate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Sulfite content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Sulfite content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 10%, 12%, 14%, 16%, 18%, 20%, 25%, 30%, 35%, 40%, 45%, or 50% by mass;
Phosphate content of at least 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1, 12%, 14%, 16%, 18%, 20%, 25%, 30%, 35%, 40%, 45%, or 50% by mass; and/or
Phosphate content of less than 0.001%, 0.005%, 0.01%, 0.05%, 0.1%, 0.2%, 0.4%, 0.6%, 0.8%, 1%, 1.5%, 2%, 3%, 4%, 5%, 6%, 7%, 8%, 9%, 1, 12%, 14%, 16%, 18%, 20%, 25%, 30%, 35%, 40%, 45%, or 50% by mass.

In some embodiments, the water demand of a lime and/or magnesium compound paste can be less than 0.2, 0.25, 0.3, 0.35, 0.4, 0.45, 0.5, 0.55, 0.6, 0.65, 0.7, 0.75, 0.8, 0.85, 0.9 on a weight basis to obtain a sufficiently flowable colloidal suspension. The water demand is determined from the rheology of a colloidal suspension of lime and water compared to a reference solution. According to one method, the reference solution is ordinary portland cement as defined by ASTM C150: Specification for Portland Cement, and water as defined by ASTM C1682: Specification for Mixing Water Used in the Production of Hydraulic Cement Concrete, in a mass ratio of 0.4:1 parts water to cement. For example, the amounts used may be 100 g of ordinary portland cement and 40 g of water. The reference suspension is used for calibration, preferably by one skilled in the art of cement testing. The test colloidal suspension may be prepared by adding 100 g of dry powdered lime to a mixing container, and adding 10 g of water. This mixture may be mixed well by hand for at least a minute, at which point the viscosity of the colloidal suspension is compared to the reference described above. If the viscosity is deemed higher than the reference solution, water may be added in 5 g increments and mixed again for one minute. This process may be repeated until the sample solution has the same viscosity as the reference solution prepared. The final water demand is determined by dividing the total amount of water added to the colloidal suspension by the starting amount of dry powdered lime used.

In some embodiments, the flow table spread of a lime and/or magnesium compound mortar can be at least 20%, 30%, 40%, 50%, 60%, 70%, 80%, 90%, 100%, 110%, 120%, 130%, 140%, or 150% as measured using the method and apparatus described in ASTM C1437: Standard Test Method for Flow of Hydraulic Cement Mortar, using a mortar with a ratio of 1:2.75 lime to Graded Test sand as defined by ASTM C109. The mortar may be prepared using a water to dry powdered lime ratio of 0.485:1 following the ratio outlined in ASTM C109, where said water is defined by ASTM C1682: Specification for Mixing Water Used in the Production of Hydraulic Cement Concrete. The mortar may be mixed in accordance with the mixing procedure included in ASTM C109: Test Method for Compressive Strength of Hydraulic Cement Mortars (using 2-in. Or [50-mm] Cube Specimens).

In some embodiments, the water demand of a lime and/or magnesium compound mortar can be less than 0.2, 0.25, 0.3, 0.35, 0.4, 0.45, 0.5, 0.55, 0.6, 0.65, 0.7, 0.75, 0.8, 0.85, 0.9 on a weight basis while obtaining a flowable colloidal suspension. The water demand of a lime mortar may be determined by preparing a mortar mix that includes dry powdered lime and Graded Test Sand as defined by ASTM C109: Test Method for Compressive Strength of Hydraulic Cement Mortars (using 2-in. Or [50-mm] Cube Specimens), in a 1:2.75 mass ratio. This mass ratio may be determined by ASTM C109, a standard ratio of cementitious material to sand. The actual amount of dry powdered lime used may be 250 g and the actual amount of sand used may be 687.5 g. Water as defined by ASTM C1682: Specification for Mixing Water Used in the Production of Hydraulic Cement Concrete, may be added initially at a weight fraction of 0.1, or 25 g, and the mixing procedure specified in ASTM C109 may be used to prepare the mortar. The mortar may be evaluated for flow using the method and apparatus found in ASTM C1437: Standard Test Method for Flow of Hydraulic Cement Mortar. If the mortar flow is less than 30%, a weight fraction of 0.05, or 12.5 g, may be added to the mortar. The mixing procedure specified in ASTM C109 may be conducted again, following which the flow determination procedure found in ASTM C1437 may be conducted. This process may be repeated until the sample suspension has a mortar flow greater than 30%. The final water demand is determined by dividing the total amount of water added to the colloidal suspension by the starting amount of dry powdered lime used. The sand is not included in the weight determination.

In some embodiments, some of these properties of the lime and/or magnesium compound may improve its performance in cement. In some embodiments, a lime and/or magnesium compound with a large primary particle diameter, small specific surface area, and/or small micropore volume may correlate with low water demand. That is to say, these properties may mean less water may be added to cement containing such lime in order to achieve sufficiently high flow, large slump, or low viscosity. This may be because particles with large primary particle diameter, small specific surface area, and/or small micropore volume adsorb or absorb smaller amounts of water, have smaller surface friction, have smaller viscous forces in suspension, and/or for other related reasons. Cements and/or concretes with lower water demand may perform better because they can have sufficient flow, slump, and/or viscosity to be cast, pumped, or poured to meet a particular application, while having less water added to the blend. Adding less water to the blend may result in higher compressive strength and/or shorter setting times. This may be because adding less water leads to lower pore volume in the hydrated, set, and/or hardened cement, mortar, or concrete, and reduced pore volume is correlated with increased compressive strength. In some embodiments, particles with certain diameters or diameter distributions may enable higher packing efficiency or filling in of gaps or voids between particles or aggregates in cement or concrete, resulting in a denser material with higher compressive strength. Cements, mortars, or concretes made with lower water to binder ratios may also have lower permeability due to lower porosity and a less interconnected pore structure (more closed and isolated pores), and therefore may resist penetration by chlorides, sulfates, or other ionic or molecular species that could lead to degradation of building materials or structures.

In some embodiments, using magnesium hydroxide (Mg(OH)₂) in place of or in combination with calcium hydroxide may allow the cement to form magnesium silicate hydrates or other magnesium-containing hydrated phases. The magnesium hydroxide may speed up or slow down the hydration reactions to control the rate of setting, hardening, and/or strength development. The magnesium hydroxide and magnesium-containing hydrated phases may improve the ultimate strength, durability, and/or permeability of the cement. In some embodiments, using components with little or no magnesium oxide content may prevent durability issues caused by delayed expansion from MgO hydration to form Mg(OH)₂. The use of Mg(OH)₂ may enable the production of a larger mass of cement by supplementing the Ca(OH)₂ available from certain feedstocks or in certain manufacturing process configurations.

In some embodiments, the lime or magnesium compound may be “electrochemical” lime or “electrochemical” magnesium hydroxide, meaning that the production of the lime or magnesium compound comprises the use of an electrochemical process or an electrochemical device. In some embodiments, the lime may be “electrolytic” lime or “electrolytic” magnesium hydroxide, meaning the lime or magnesium compound is produced in a process that uses an electrolyzer. In some embodiments, the lime or magnesium compound may be “precipitated” lime or “precipitated” magnesium hydroxide, meaning it is produced via a precipitation reaction. In some embodiments, the lime or magnesium compound will be a “decarbonized” lime or magnesium compound or “carbon-neutral” lime or magnesium compound, meaning it is produced via a process with reduced or zero carbon dioxide emissions. In some embodiments, the embodied carbon dioxide of the lime or magnesium compound will be at least 50%, at least 60%, at least 70%, at least 80%, at least 90%, at least 95%, at least 98%, at least 99%, or 100% lower than lime or magnesium oxide or hydroxide manufactured using incumbent carbon-intensive technologies. Such technologies may include the production of lime from carbonates such as limestone and in which the CO₂ emissions are not captured and sequestered or utilized, or where process emissions are incurred by heating said lime or its precursors by the combustion of fossil fuels.

In some embodiments, “electrochemical methods” may include any process wherein electricity is used to power a device with a positive electrode, a negative electrode, and an electrolyte, wherein said electrolyte or a product of the electrochemical reaction of the electrolyte is used to carry out a chemical or electrochemical reaction with a source of calcium. In some embodiments, said electricity may be produced at least in part using a non-fossil-fuel source of energy. In some embodiments, an electrochemical reactor may be used to produce acid and/or base from an aqueous electrolyte. The electrolyzer may be powered by renewable, non-fossil-fuel sources of electricity such as solar or wind energy. The electrolyzer may produce an acid that may be used to leach calcium ions from a calcium-bearing mineral input (e.g., waste concrete/cement, fly ash, bottom ash, incinerator ash, steel slag, iron slag or other similar sources). In some embodiments, calcium hydroxide is precipitated from the resulting solution of Ca²⁺ ions upon mixing said solution with a base. In some embodiments, the base may also be produced by an electrolyzer. In some embodiments, said acid may be obtained from a non-electrolytic source, and said base may be obtained from an electrolytic source, or vice versa.

In some embodiments, both the acid and the base are provided from a non-electrolytic source. Nonetheless, by using the afore-mentioned dissolution and/or precipitation processes to produce lime, the use of fossil fuels as a source of heat may be reduced or avoided entirely.

In some embodiments, the lime and/or magnesium compound may be produced from a calcium and/or magnesium-containing source material that is already substantially decarbonated. This material may comprise construction and demolition waste; recycled or waste concrete, cement, mortar; a calcium-containing and/or magnesium-containing naturally occurring mineral such as a basaltic mineral, limestone, dolomitic limestone, or wollastonite; ash resulting from combustion, including but not limited to coal ash, fly ash, bottom ash, and incinerator ash, or other similar materials. In some embodiments, the lime and/or magnesium compound may be produced from these decarbonized or waste materials using the methods described above. In some embodiments, the dissolution of these feedstock materials substantially or completely avoids the release of CO₂ molecules.

In some embodiments, the feedstock material used to produce the lime and/or magnesium compound may comprise one or more of the following materials: mine tailings (e.g., tailing from boron extraction from ulexite), metallurgical slags (blast furnace slag, ladle slag, electric arc furnace slag, basic oxygen furnace slag, copper slag, etc.), coal ash (bottom ash, fly ash, ponded ash, economizer ash, etc.), municipal solid waste incinerator ash, recycled or waste construction materials (e.g., crushed concrete), waste from aluminum anodization processes (e.g. spent pot liners), sludge from water treatment processes, clay, bauxite, waste from aluminum production or refining processes (e.g. red mud, red sludge, alumina refinery residue), lime kiln dust, and/or cement kiln dust. In some embodiments, the lime and/or magnesium compound may be produced using an integrated process from the same feedstock used to other components of the additive or cementitious binder, such as the aluminum compound/additive and/or siliceous material/pozzolan.

In some embodiments, waste materials from the process of manufacturing lime and/or cement may be used as the source of calcium. These may include lime kiln dust or cement kiln dust. In some embodiments, these materials may be lime in the form of quicklime (CaO), and may be used directly in producing a cement blend. In some embodiments, the lime kiln dust or cement kiln dust may be used as a feedstock material for a process to produce lime, including by the methods described above. In some embodiments, the use of lime kiln dust or cement kiln dust comprises the use of a decarbonized source of lime even if the process originally used to produce said lime uses fossil fuels or emits chemical CO₂ from the decomposition of calcium carbonate or limestone, because the use of said waste material displaces the use of a calcium source or process that does release CO₂ emissions to the atmosphere. In some embodiments, the lime kiln dust or cement kiln dust may be produced in a process that does not result in CO₂ emissions to the atmosphere, due to the use of an electric kiln or calciner and/or by capturing and sequestering CO₂ emissions, or beneficially using such CO₂ emissions in other products or applications.

Returning to FIG. 6, the process stream or leachate 6602 can be reacted in one or more reaction chambers with a base. In some embodiments, the process stream or leachate 6602 can be reacted in one or more reaction chambers with a base generated by the electrolyzer to form at least one solid product (e.g., magnesium, iron, aluminum, and/or manganese oxides and hydroxides). For example, the process stream or leachate 6602 can be reacted in a reaction chamber 602 with the base (e.g., NaOH) 610 generated by the electrolyzer 600 to form a solid product 6603 and a process stream or leachate 608 (e.g., brine stream). In some embodiments, the solid product can include iron oxides and/or iron hydroxides as well as oxides and/or hydroxides of other metals in the first insoluble product. In some embodiments, the solid product can include iron oxyhydroxides as well as oxyhydroxides of other metals. In some embodiments, the product stream can include an iron product. In some embodiments, the solid product can include magnesium oxides and/or hydroxides as well as oxides and/or hydroxides of other metals in the feed material. In some embodiments, the solid product can include magnesium hydroxide. In some embodiments, the product stream can include a magnesium product. In some embodiments, the solid product can include aluminum and/or manganese. In some embodiments, the product stream 6603 can be a solids fraction including a precipitated product generated by the reaction of the leachate or process stream 6602 with the base from the electrolyzer. In some embodiments, the solid product 6603 may be collected and stored in a suitable container. In some embodiments, the leachate or process stream can be a liquid fraction or leachate that includes a salt of the anion from the acid. In some embodiments, the leachate or process stream 608 (e.g., brine or salt stream) may be recycled to the electrolyzer 600. In some embodiments, the leachate or process stream can be sent to the electrolyzer in order to regenerate the acid and/or base. The brine process stream 608 may have a pH of greater than 10, such as a pH ranging from about 11 to about 14. In some embodiments, the reaction chamber 602 can be multiple reaction chambers in series such as reaction chambers 102 and 103 shown in FIGS. 1-3. For example, the precipitation of the iron solids product and the precipitation of the magnesium solids product from the second leaching cycle can occur according to any of the processes shown and described in FIGS. 1-3.

In some embodiments, it may be desirable to operate a leaching process using a batch reactor, backed bed reactor, plug flow reactor, cross flow reaction train, or series of CSTRs configuration. In said configurations, the pH and/or temperature can vary across the reactors as the reaction progresses and the acid is neutralized. Variation in temperature and/or pH can cause some components, such as the iron or aluminum, to initially dissolve at lower pH and/or cooler regions of the leaching reactor system and then precipitate at higher pH and higher temperature regions of the leaching reactor system. Such dissolution and precipitation cycles can modify the morphological properties, crystallinity, and chemical structure of aluminum and iron species leading to materials with improved properties of reactivity (as measured by the Pozzolanic Reactivity Test or R³ test), mortar performance and/or greater processability (filterability and reduced moisture content). In some embodiments, a single feed material may be added at multiple locations along the reactor system or different feed materials may be added at different locations such that each feed material is exposed to the preferred pH to enact the desired leaching.

In some embodiments, the pH within each of the reaction chambers may be controlled by selective component addition to selectively promote formation of products from the reaction chambers. In some embodiments, each of the chambers 101, 102, 103, 104, 602 may be controlled by selective component addition, in order to selectively promote the formation of the products 01, 03, 05, 07, 6603. For example, the first reaction chamber 101 may have the lowest pH, and the second-fourth reaction chambers 102, 103, 104, may have progressively higher pH's. In some embodiments, reacting the second leachate with the base can occur at a higher pH than reacting the first leachate with the base. In addition, reacting the third leachate with the base can occur at a higher pH than reacting the second leachate with the base. In some embodiments, the pH can be controlled during the reactions such that reacting the feed material with the weak acid occurs at a first pH, reacting the first leachate with the base occurs at a second pH higher than the first pH, and reacting the second leachate with the base occurs at a third pH higher than the second pH. For example, reacting the feed material with the weak acid can occur at a pH of about 2 to about 7; reacting the first leachate with the base can occur at a pH of about 6 to about 11; and reacting the second leachate with the base can occur at a pH of about 7 to about 13. In some embodiments, reacting the first insoluble product with the acid can occur at a pH of about 0-5. In some embodiments, reacting the leachate from the insoluble product leaching with a base can occur at a pH of about 3-12. In some embodiments, a pH of the first reaction chamber is maintained at about 2-7; a pH of the second reaction chamber is maintained at about 6-11; and a pH of the third reaction chamber is maintained at about 7-13. In some embodiments, a pH of the second leaching chamber is maintained at 0-5. In some embodiments, a pH of the precipitation chamber after second leaching is maintained at about 3-12.

In some embodiments, the system may be preloaded with reactants. For example, acids and/or bases may be loaded into the reaction chambers prior to supplying any feed material.

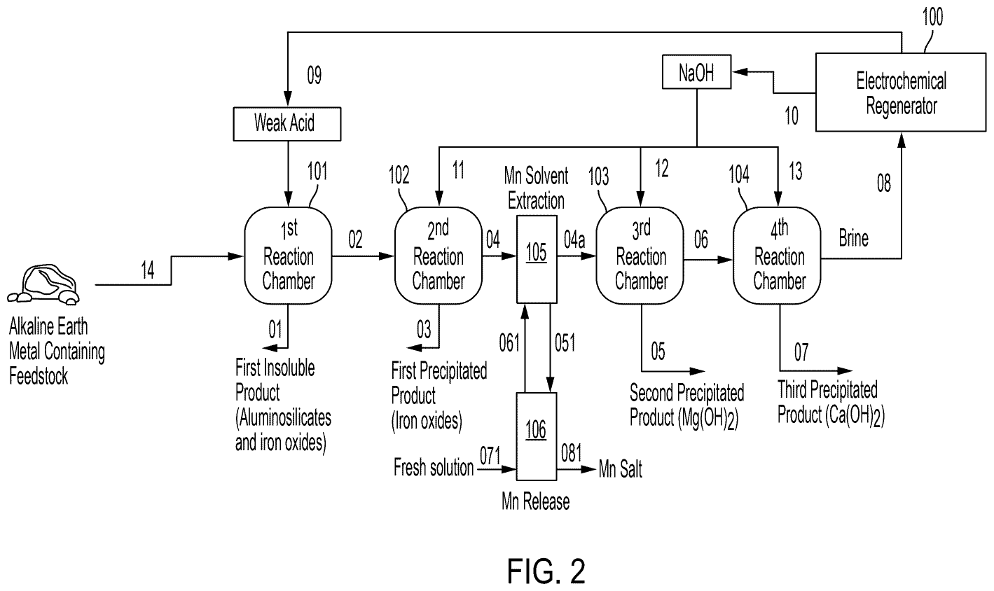

FIG. 2 is a schematic diagram of a leaching system with three precipitation steps and a transition metal extraction step and a corresponding leaching method process flow, according to various embodiments of the present disclosure. The system may be similar to that of FIG. 1 with differences discussed below.

Referring to FIG. 2, the leaching and precipitation system may include a transition metal extractor 105. In some embodiments, the transition metal extractor can be a separation column configured to receive second leachate or process stream 04 from reaction chamber 102. In some embodiments, the second leachate or process stream 04 can include at least one or a mixture of transition metals or salts. In some embodiments, the transition metals include nickel, manganese, chromium, and/or molybdenum. In some embodiments, the high value transition metal salt solution feed may be provided directly to the extractor 105 where transition metals like nickel, manganese, chromium, and/or molybdenum may be extracted using solvent extraction technique (e.g., liquid-liquid extraction) or by ion-exchange (e.g., ion exchange resin). In some embodiments, the system for separating high value transition metals may act on leachates or process streams 02, 04, or 06.

In some embodiments, such as in a liquid-liquid extraction technique, the solution stream may be circulated from tank/reservoir 106 as stream 061 into column 105 to interact with a solution (e.g., leachate or process stream) containing transition metals. Via solvent extraction, the transition metal can be recovered in solution stream 051 into tank or reservoir 106, where the transition metal can be extracted in salt form as product stream 081. In some embodiments, the residual stream after transition metal extraction, can be directed to another reaction chamber (e.g., the 3^{rd} reaction chamber 103) as a leachate or process stream (e.g., leachate or process stream 04a) for precipitation of alkali metal products as described above.

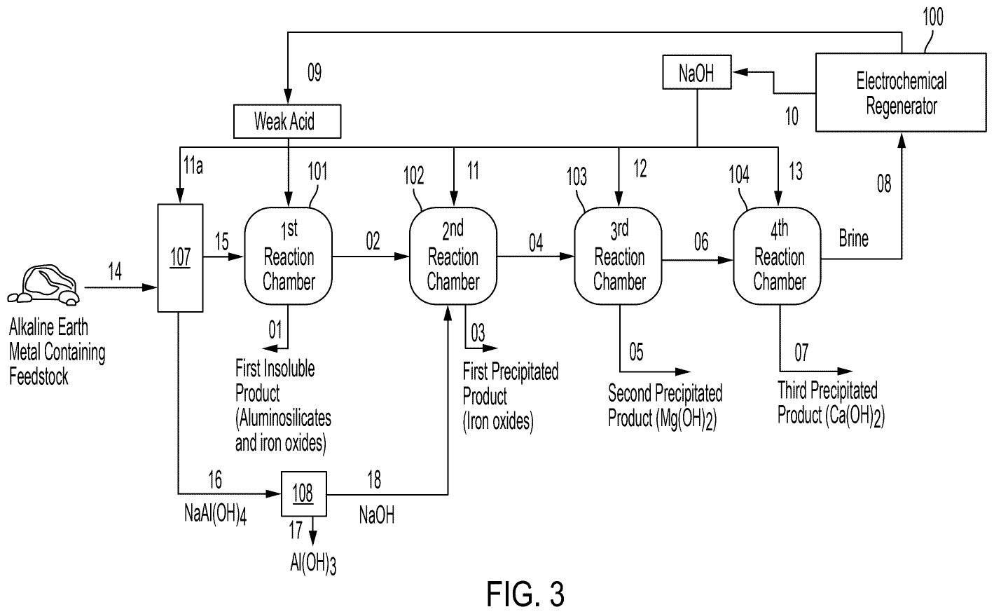

FIG. 3 is a schematic diagram of a leaching system with three precipitation steps and base leaching of aluminum using the hydroxide base and a corresponding leaching method process flow, according to various embodiments of the present disclosure.

Referring to FIG. 3, the system may include a reactor 107, which may include a base heater, and fifth reaction chamber 108 that are fluidly connected to a base outlet of the electrolyzer. In some embodiments, a base 10 output from the electrolyzer 100 may be sequentially provided to the reactor 107 (as 11a), the fifth reaction chamber 108, before being divided between the second 102, third 103, and the fourth 104 reaction chambers. In some embodiments, the reactor 107 may heat the base to facilitate leaching and may accomplish the heating via resistive, inductive, and/or gas combustion. In some embodiments, the reaction may occur at a temperature ranging from about 100° C. to about 300° C., such as from about 150° C. to about 200° C.

In some embodiments, the feed material 14 may include a significant amount of aluminum, which may be in the form of oxides, salts, and/or hydroxides of aluminum. In some embodiments, a reaction between the feed material 14 and the base 11a provided to the reactor 107 may form a process stream 15 that may be output from the reactor 107 to the reaction chamber 101 where it is contacted/reacted with the weak acid 09. In some embodiments, the process stream 15 may contain less than 75%, less than 50%, or less than 25% of the aluminum initially fed into reactor 107 via the feed material 14.

In some embodiments, prior to reacting the feed material with the weak acid, the feed material is reacted with the base to produce a leachate or process stream comprising aluminum. In some embodiments, process stream 16 may be provided to the fifth reaction chamber 108 where solubilized aluminum (e.g., aluminum hydroxide) in process stream 16 can be precipitated in product 17. In some embodiments, fifth process stream 16 may include dissolved sodium aluminate (NaAl(OH)₄) recovered from the feed material 14. In some embodiments, in reaction chamber 105, the process stream 16 may be cooled to a temperature ranging from about 100° C. to about 10° C., such as from about 30° C. to about 60° C. For example, cooling water or air may be provided to the fifth reaction chamber 108 to reduce the temperature of the process stream 16 and promote the generation of an aluminum product 17 and/or release of the base absorbed in reactor 107. Alternatively, in some embodiments, an acid or acid gas may be added to the fifth reaction chamber 108 to induce the precipitation of the aluminum hydroxide and produce a salt such as sodium acetate or sodium carbonate that would be present in stream 18. In some embodiments, the aluminum product 17 may be a solids fraction including precipitated aluminum hydroxide Al(OH)₃. In some embodiments, the aluminum product 17 may be stored in a suitable container. In some embodiments, a base stream 11, 12, and 13 including unreacted and/or released base generated by the electrolyzer 100 may be provided to the second 102, third 103, and the fourth 104 reaction chambers.

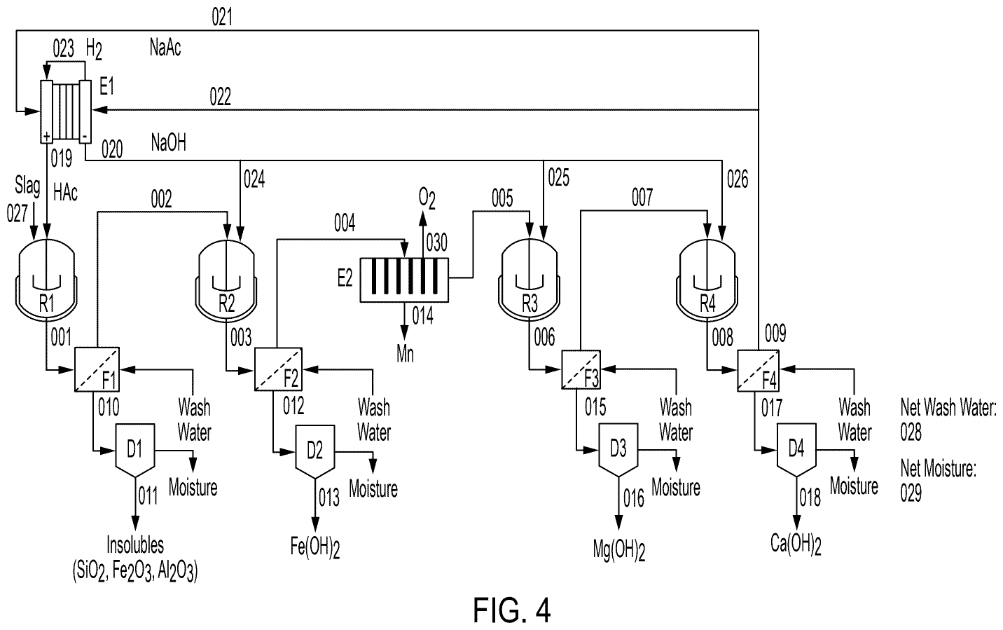

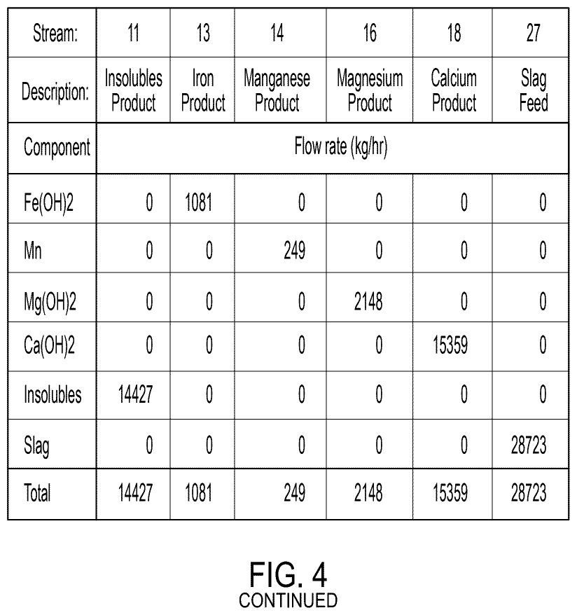

FIG. 4 is a process flow diagram of a leaching system with three precipitation steps and a transition metal extraction step including additional detail such as filtration and drying as well as a mass balance table for major inputs and outputs. The mass balance was prepared based on data obtained in leaching experiments of an EAF slag in acetic acid where the slag was dissolved in excess quantities of 4M acetic acid at 100° C. for 4 hours. The insoluble product recovered from these experiments had a total heat release of 133 Joules/gram during isothermal calorimetry testing based on the Pozzolan Reactivity test, indicating reactivity. In some embodiments, it may be desirable to have a heat release greater than 90 Joules/gram SCM, and most desirable to have a heat greater than 125 Joules/gram SCM.

In some embodiments, the products generated by the above systems and methods may be used in various applications and/or subjected to further processing and/or purification. For example, as previously described, calcium hydroxide and amorphous aluminosilicates may be used as components for the manufacture of construction materials such as cement and/or concrete, without the need for decomposing mined limestone, which may reduce environmental impacts. In addition, by generating separate products, the present systems and methods may provide increased value and product applications. In many cases, the feed materials would otherwise be landfilled or used for low value purposes such as road base. Using them to make products can increase their circularity and recycles valuable metals.

Various embodiments may be configured to provide appropriate residence times, pH controls, and/or recycle loops, in order to significantly reduce acid consumption while generating multiple concentrated precipitated products (e.g., silicates, aluminum hydroxide, iron oxides, etc.). In some embodiments, the concentrated component streams may be further purified in order to produce saleable products and/or to produce products that may be blended into construction materials such as cement and/or concrete. Additionally, alkaline metals, such as magnesium and/or calcium, can be extracted via precipitation through the addition of base such as hydroxide and/or ammonia solutions or heated to decompose the metal salts into metal oxides. In some embodiments, iron species may be extracted in oxide or hydroxide forms suitable for iron ores or pigments.

In some embodiments, feedstocks, intermediate streams, and product streams may undergo comminution processes such as grinding or crushing. Further, these streams may undergo size and/or density classification processes through hydrodynamic or gravity-based means to separate out different materials and/or particle sizes. In some embodiments, two materials may be fed into a reactor or reactor system with different particle sizes to facilitate their separation upon exiting the reactor or reactor system. In some embodiments, one or more of the reactors may be such that they serve as both a reactor and simultaneously comminute the material within.

In some embodiments, when using a concentrated base, aluminum hydroxide, aluminum oxyhydroxide, or aluminum oxide can be separated from either the feed material prior to leaching or from the solid product of the first leaching step through high temperature dissolution, separation of the remaining solids, and/or precipitation of the aluminum hydroxide, oxide, or oxyhydroxide via cooling or the addition of an acid or acid gas such as carbon dioxide. If silica is present along with iron oxides and aluminum hydroxide, the silica can be separated from the iron oxides via a gravity-based method due to the higher density of iron compounds. Introduction of different components into the reactor system with differing particle size may also assist this separation.

In some embodiments, it may be preferable to mix two or more pozzolans with different properties—at least one with high specific surface area and at least one with good flow properties—to create an ideal pozzolan mixture for cement blending. Such a mixture can be accommodated by adding one or more different feed materials into the reactor that generate insoluble products with different pozzolanic properties or blending the insoluble products with pozzolans, limestone, and/or gypsum to make a blended supplementary cementitious materials with desirable properties.

### EXAMPLES

Example 1: An arc furnace slag was processed using acetic acid. The amount of acetic acid used was calculated based on the stoichiometric quantity required to dissolve 93% of the calcium oxide measured using x-ray fluorescence assuming two moles of acid were required to dissolve each mole of calcium oxide. The processing was performed in batch at a temperature above 60° C. for more than 2 hours. The resulting slurry was allowed to cool and then filtered using vacuum filtration. The final filtrate pH was greater than 6, indicating that the cation removal would be targeted on highly soluble components such as Ca, Mg, and Mn. The filtrate was further analyzed using inductively coupled plasma atomic emission spectroscopy (ICP-AES) and found to have extracted approximate 0.24 kg of calcium per kg of feedstock. The total mass of extracted cations was 0.27 kg, indicating a selectivity of approximately 89%. The selectivity of the combination of magnesium and calcium was approximately 96%.

Example 2: An arc furnace slag was processed in two stages, first with acetic acid (Leach 1 in FIG. 6) and subsequently with sodium bisulfate (Leach 2 in FIG. 6). For Leach 1, the amount of acetic acid was calculated based on the stoichiometric quantity of acid required to dissolve 80% of the calcium oxide measured using x-ray fluorescence assuming two moles of acid were required to dissolve each mole of calcium oxide. The processing was performed in batch at a temperature above 60° C. for more than 2 hours. The resulting slurry was allowed to cool and then filtered using vacuum filtration. The final filtrate was analyzed using ICP-AES and found to have extracted approximately 0.30 kg of calcium per kg of feedstock. The total mass of extracted cations was 0.34 kg, indicating a selectivity of approximately 88%. The selectivity of the combination of magnesium and calcium was approximately 96%.

The insoluble phase recovered from the slurry was then washed with deionized water and dried. The dried solids were then processed with sodium bisulfate. The amount of sodium bisulfate was calculated to be in excess of the stoichiometric quantity of acid required to dissolve 100% of the iron oxide and magnesium oxide measured using x-ray fluorescence assuming two moles of acid were required to dissolve each mole of iron oxide and two moles of acid were required to dissolve each mole of magnesium oxide. The processing was performed in batch at a temperature above 60° C. for more than 2 hours. The resulting slurry was allowed to cool and then filtered using vacuum filtration. The final filtrate was analyzed using ICP-AES and found to have extracted approximately 0.7 kg of Fe per kg of feedstock and 0.05 kg of Mg per kg of feedstock. The total mass of extracted cations was 0.20 kg, indicating a combined iron and magnesium selectivity of 60%. The insoluble portion recovered after Leach 2 was collected as a supplementary cementitious material (SCM). This SCM was then characterized via R3, a test designed to assess the reactivity of SCMs by measuring the amount of heat released after the SCM is combined in a simplified system to reproduce the environment of a hydrating cement. The heat release from this SCM was 252 J/g SCM. This two-step leaching process can have several benefits compared to processing with a single leaching stage. For example, a sample of the same EAF slag, leached with an equivalent total amount of acid, but only in a single acetic-leaching stage produced a less reactive SCM which generated a heat release of only 110 J/g SCM. Furthermore, this single-stage leaching produced a stream which was less selective for Ca and Mg. Utilizing different acids in a two-stage process can allow for isolation of the Ca and Mg in a higher-purity alkaline earth metal stream which can be precipitated separately from the remaining Mg and Fe present in the secondary stream, as shown in FIG. 6.

### Additional Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, unless stated otherwise, room temperature is 25° C., and standard temperature and pressure is 25° C. and 1 atmosphere. Unless expressly stated otherwise all tests, test results, physical properties, and values that are temperature dependent, pressure dependent, or both, are provided at standard ambient temperature and pressure.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, a statement that the fraction of the weak acid present in its conjugate base form may be less than about 100%, about 90%, or about 80% is meant to mean that the fraction of the weak acid present in its conjugate base from may be less than about 100%, less than about 90%, or less than about 80%.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
reacting a feed material comprising at least two metals selected from the group consisting of iron, magnesium, and calcium with a weak acid at a pH of 2-7 to produce a first leachate comprising ions of the at least two metals and an insoluble product, wherein the weak acid consumption of the reaction is less than 25 moles of weak acid per kg of feed material;
reacting the first leachate with a base to produce a first solid product comprising a first metal and a second leachate comprising ions of a second metal different from the first metal; and
reacting the second leachate with the base to produce a second solid product comprising the second metal and a third leachate,
wherein reacting the second leachate with the base occurs at a higher pH than reacting the first leachate with the base.

2. The method of claim 1, wherein:
the weak acid comprises an organic acid selected from the group consisting of formic acid, chloroacetic acid, dichloroacetic acid, and acetic acid (CH₃COOH); and
the base comprises sodium hydroxide (NaOH), ammonium hydroxide, or potassium hydroxide (KOH).

3. The method of claim 1, wherein the insoluble product comprises silicate, silicon dioxide (SiO₂), and/or aluminosilicate.

4. The method of claim 1, wherein the second solid product comprises calcium hydroxide and/or the first solid product comprises magnesium hydroxide.

5. (canceled)

6. The method of claim 1, wherein an amount of weak acid used in the reaction is between 80% and 120% of the stoichiometric amount required to dissolve all calcium oxide in the feed material as measured by XRF and assuming two moles of acid are required per mole of calcium oxide.

7. The method of claim 6, wherein calcium cations make up at least 80% by weight of all leached cations in the first leachate as measured by ICP of the first leachate.

8. The method of claim 1, wherein an amount of weak acid used in the reaction is between 80% and 120% of the stoichiometric amount required to dissolve all calcium oxide and magnesium oxide in the feed material as measured by XRF and assuming two moles of acid are required per mole of calcium oxide and two moles of acid are required per mole of magnesium oxide.

9. The method of claim 8, wherein calcium and magnesium cations make up at least 80% by weight of all leached cations in the first leachate as measured by ICP of the first leachate.

10. The method of claim 1, wherein the second solid product has a platelet morphology with as aspect ratio greater than 2 and/or a tap density greater than 0.8 g/mL.

11. (canceled)

12. The method of claim 1, further comprising reacting the insoluble product with a second acid having a lower pKa than the weak acid to produce a second insoluble product and a leachate of the second acid.

13. The method of claim 12, wherein the second acid comprises chloroacetic acid, dichloroacetic acid, lactic acid, formic acid, citric acid, oxalic acid, monobasic citrate, monobasic phosphate, dibasic phosphate, bisulfate, or bicarbonate.

14. The method of claim 1, further comprising, prior to reacting the feed material with the weak acid, reacting the feed material with the base to produce a fourth leachate comprising aluminum, wherein the feed material comprises aluminum.

15. The method of claim 1, further comprising reacting the insoluble product with the base to produce a fifth leachate comprising aluminum, wherein the feed material comprises aluminum.

16. The method of claim 1, further comprising precipitating the aluminum from the fourth and/or fifth leachate using a temperature swing and/or through the addition of an acid or acid gas.

17. The method of claim 16, wherein the aluminum is precipitated using carbon dioxide forming a carbonate salt and the carbonate salt is added to the reaction of the first leachate with the base to produce the first solid product.

18. The method of claim 16, wherein the aluminum is precipitated using the weak acid to form aluminum hydroxide and a sixth leachate comprising the anion of the weak acid.

19. The method of claim 1, further comprising extracting a transition metal comprising nickel, manganese, chromium, and/or molybdenum, wherein the feed material comprises the transition metal, wherein extracting comprises a liquid-liquid extraction or an ion exchange resin and removes the transition metal from the first and/or second leachate.

20. (canceled)

21. The method of claim 1, wherein reacting the feed material with the weak acid occurs in a first reaction chamber comprising regions of different pH or a pH that varies temporally.

22. (canceled)

23. (canceled)

24. The method of claim 21, wherein the variation in pH causes a portion of aluminum or iron in the feed material to dissolve and then precipitate and to be incorporated into the insoluble product.

25. The method of claim 24, wherein the insoluble product comprises more than 5 wt. % material precipitated in the first reaction chamber.

26. The method of claim 1, wherein the insoluble product comprises more than 90% of aluminum in the feed material.

27. The method of claim 1, wherein:
reacting the first leachate with the base occurs at a pH of about 6 to about 11; and
reacting the second leachate with the base occurs at a pH of about 7 to about 13.

28. The method of claim 1, further comprising controlling pH during the reactions such that reacting the feed material with the weak acid occurs at a first pH, reacting the first leachate with the base occurs at a second pH higher than the first pH, and reacting the second leachate with the base occurs at a third pH higher than the second pH.

29. The method of claim 1, wherein more than 75 wt. % of the iron in the feed material ends up in the insoluble product.

30. The method of claim 1, wherein a mass ratio of calcium to iron in the first leachate is greater than 5.

31. The method of claim 1, wherein the feed material is a metallurgical slag, municipal solid waste, mine tailings, and/or recycled concrete.

32. The method of claim 31, wherein the feed material comprises more than 10 wt. % iron as measured as Fe₂O₃ by XRF.

33-38. (canceled)

39. A system comprising:
a first reaction chamber configured to receive a feed material comprising at least two metals selected from the group consisting of iron, magnesium, and calcium and a weak acid and react the feed material with the weak acid at a pH of 2-7 to produce a first leachate comprising ions of the at least two metals and an insoluble product, wherein the weak acid consumption of the reaction is less than 25 moles of weak acid per kg of feed material;
a second reaction chamber configured to receive the first leachate and a base and react the first leachate with the base to produce a first solid product comprising a first metal and a second leachate comprising ions of a second metal different from the first metal; and
a third reaction chamber configured to receive the second leachate and the base and react the second leachate with the base to produce a second solid product comprising the second metal and a third leachate,
wherein the third reaction chamber is maintained at a higher pH than the second reaction chamber.

40-45. (canceled)
